(19) United States
(12) Patent Application Publication
(10) Pub. No.: US 2016/0339602 A1
(43) Pub. Date: Nov. 24, 2016

(54) METHOD OF MANUFACTURING THREE-DIMENSIONAL STRUCTURE, THREE-DIMENSIONAL STRUCTURE MANUFACTURING APPARATUS, AND THREE-DIMENSIONAL STRUCTURE

(71) Applicant: SEIKO EPSON CORPORATION, Tokyo (JP)

(72) Inventors: Shinichi KATO, Matsumoto, Nagano (JP); Koki HIRATA, Matsumoto, Nagano (JP); Hiroshi FUKUMOTO, Shiojiri, Nagano (JP); Chigusa SATO, Shiojiri, Nagano (JP)

(73) Assignee: SEIKO EPSON CORPORATION, Tokyo (JP)

(21) Appl. No.: 15/111,063

(22) PCT Filed: Mar. 23, 2015
(86) PCT No.: PCT/JP2015/001612

§ 371 Date: Jul. 12, 2016

(30) Foreign Application Priority Data
Mar. 26, 2014 (JP) 2014-063429

(51) Int. Cl. B28B 1/00; B29C 71/02; B33Y 10/00; B22F 3/10; B33Y 40/00; B33Y 50/02; B33Y 80/00; B29C 67/00; B33Y 30/00

(52) U.S. Cl. CPC B28B 1/001; B29C 67/0081; B29C 67/0088; B29C 67/0092; B29C 67/0096; B29C 71/02; B33Y 10/00; B33Y 30/00; B33Y 40/00; B33Y 50/02; B33Y 80/00; B22F 3/1017; B29K 2105/251

(57) ABSTRACT

The present invention is to provide a method of manufacturing a three-dimensional structure capable of manufacturing a three-dimensional structure having excellent mechanical strength with high productivity, a three-dimensional structure manufacturing apparatus capable of manufacturing a three-dimensional structure having excellent mechanical strength with high productivity, and a three-dimensional structure manufactured using the method of manufacturing a three-dimensional structure.

The method includes a layer formation step of forming a layer using a composition including particles and an aqueous solvent; and a binding liquid application step of applying a binding liquid to the layer to bind the particles, in which a temporary formed body obtained by repeating a series of steps including the layer formation step and the binding liquid application step, and the method further includes a temporary formed body heating step of performing a heating treatment on the temporary formed body.

### TECHNICAL FIELD

The present invention relates to a method of manufacturing a three-dimensional structure, a three-dimensional structure manufacturing apparatus, and a three-dimensional structure.

### BACKGROUND ART

There has been known a technique for forming a material layer (unit layer) using a composition including powder (particles) and laminating the layers to forma three-dimensional structure (for example, refer to PTL 1). in the technique, a three-dimensional structure is formed by repeating the following operations. First, powder is thinly spread with a uniform thickness to form a material layer and the powder particles are selectively bound to each other in only the desired portion of the material layer to forma binding portion. As a result, a thin plate-like member (hereinafter, referred to as a “cross-sectional member”) is formed in the binding portion in which the powder particles are bound to each other.

Then, another material layer is further formed on the material layer and the powder particles are selectively bound to each other in only the desired portion to form a binding portion. As a result, a new cross-sectional member is formed on a newly formed material layer. At this time, the newly formed cross-sectional member is bound to the previously formed cross-sectional member. These operations are repeated to sequentially laminate the thin plate-like cross-sectional members (bonding portions), thereby forming a three-dimensional structure.

However, in such a technique, a problem arises that the strength of a finally obtained three-dimensional structure is deteriorated.

### CITATION LIST

### Patent Literature

[PTL 1]

JP-A-2003-53847

### SUMMARY OF INVENTION

### Technical Problem

Accordingly, it is an object of the invention to provide a method of manufacturing a three-dimensional structure capable of manufacturing a three-dimensional structure having excellent mechanical strength with high productivity, a three-dimensional structure manufacturing apparatus capable of manufacturing a three-dimensional structure having excellent mechanical strength with high productivity, and a three-dimensional structure manufactured using the method of manufacturing a three-dimensional structure.

### Solution to Problem

Such an object can be achieved by the following invention.

According to an aspect of the invention, there is provided a method of manufacturing a three-dimensional structure including a layer formation step of forming a layer using a composition including particles and an aqueous solvent, and a binding liquid application step of applying a binding liquid to the layer to bind the particles, in which a temporary formed body obtained by repeating a series of steps including the layer formation step and the binding liquid application step, and the method further includes a temporary formed body heating step of performing a heating treatment on the temporary formed body.

Accordingly, it is possible to provide a method of manufacturing a three-dimensional structure capable of manufacturing a three-dimensional structure having excellent mechanical strength with high productivity.

In the method of manufacturing a three-dimensional structure according to the aspect, it is preferable that the temporary formed body heating step is performed after the particles which are not bound by the binding liquid are removed from the temporary formed body.

Accordingly, the productivity of a three-dimensional structure can be particularly improved. In addition, unintentional deformation and deterioration in the constituent material of a three-dimensional structure can be more effectively prevented and the removing of the unbound particles is preferable from the viewpoint of energy saving.

In the method of manufacturing a three-dimensional structure according to the aspect, it is preferable that the temporary formed body heating step is performed in a state in which the temporary formed body is surrounded by the particles which are not bound by the binding liquid and then the particles which are not bound by the binding liquid are removed.

Accordingly, the dimensional accuracy of a three-dimensional structure can be particularly improved.

In the method of manufacturing a three-dimensional structure according to the aspect, it is preferable that a heating temperature in the temporary formed body heating step is 50 degrees Celsius or higher and 180 degrees Celsius or lower.

Accordingly, the mechanical strength and dimensional accuracy of a three-dimensional structure can be particularly improved while particularly improving the productivity of the three-dimensional structure. Further, unintentional deformation and deterioration in the constituent material of the three-dimensional structure can be more effectively prevented.

In the method of manufacturing a three-dimensional structure according to the aspect, it is preferable that when a glass transition temperature of a binding agent which binds the particles in the temporary formed body is Tg [degrees Celsius], a heating temperature in the temporary formed body heating step is (Tg−20) degrees Celsius or higher and (Tg+20) degrees Celsius or lower.

Accordingly, the mechanical strength and dimensional accuracy of a three-dimensional structure can be particularly improved while particularly improving the productivity of the three-dimensional structure. Further, unintentional deformation and deterioration in the constituent material of the three-dimensional structure can be more effectively prevented.

In the method of manufacturing a three-dimensional structure according to the aspect, it is preferable that a heating time in the temporary formed body heating step is 1 minute or more and 180 minutes or less.

Accordingly, the mechanical strength and dimensional accuracy of a three-dimensional structure can be particularly improved while particularly improving the productivity of the three-dimensional structure.

In the method of manufacturing a three-dimensional structure according to the aspect, it is preferable that an infrared heater is used in the temporary formed body heating step.

Accordingly, even when the size of a three-dimensional structure to be manufactured is large, the method can suitably cope with the size.

In the method of manufacturing a three-dimensional structure according to the aspect, it is preferable that the layer to which the binding liquid is applied is subjected to a heating treatment before the temporary formed body heating step.

Accordingly, the mechanical strength, dimensional accuracy, and reliability of a three-dimensional structure can be particularly improved.

In the method of manufacturing a three-dimensional structure according to the aspect, it is preferable that the series of steps further include a layer heating step of performing a heating treatment on the layer between the layer formation step and the binding liquid application step.

Accordingly, the mechanical strength of a three-dimensional structure can be further improved.

In the method of manufacturing a three-dimensional structure according to the aspect, it is preferable that a first heating treatment and a second heating treatment in which the layer is heated at a temperature higher than in the first heating treatment are performed in the layer heating step.

Accordingly, the mechanical strength of a three-dimensional structure can be particularly improved.

In the method of manufacturing a three-dimensional structure according to the aspect, it is preferable that hot air is used in the layer heating step.

Accordingly, the productivity of a three-dimensional structure can be particularly improved.

In the method of manufacturing a three-dimensional structure according to the aspect, it is preferable that a heating temperature in the first heating treatment is 30 degrees Celsius or higher and 70 degrees Celsius or lower.

Accordingly, the mechanical strength and dimensional accuracy of a three-dimensional structure can be particularly improved while particularly improving the productivity of the three-dimensional structure.

In the method of manufacturing a three-dimensional structure according to the aspect, it is preferable that a heating temperature in the second heating treatment is 40 degrees Celsius or higher and 120 degrees Celsius or lower.

Accordingly, the mechanical strength and dimensional accuracy of a three-dimensional structure can be particularly improved while particularly improving the productivity of the three-dimensional structure.

In the method of manufacturing a three-dimensional structure according to the aspect, it is preferable that a treatment time for the first heating treatment is 0.1 second or more and 60 seconds or less.

Accordingly, the mechanical strength of a three-dimensional structure can be particularly improved while particularly improving the productivity of the three-dimensional structure.

In the method of manufacturing a three-dimensional structure according to the aspect, it is preferable that a treatment time for the second heating treatment is 0.1 second or more and 60 seconds or less.

Accordingly, the mechanical strength of a three-dimensional structure can be particularly improved while particularly improving the productivity of the three-dimensional structure.

In the method of manufacturing a three-dimensional structure according to the aspect, it is preferable that the heating temperature in the temporary formed body heating step is higher than the heating temperature in the layer heating step.

Accordingly, the internal stress can be more effectively alleviated and thus the mechanical strength and dimensional accuracy of a three-dimensional structure can be particularly improved.

According to another aspect of the invention, there is provided a three-dimensional structure manufacturing apparatus that manufactures a three-dimensional structure by laminating layers using a composition including particles, including a stage on which the layer is formed by applying the composition, binding liquid application means for applying a binding liquid to the layer to bind the particles, and temporary formed body heating means for performing a heating treatment on a temporary formed body formed by laminating the layers to which the binding liquid is applied.

Accordingly, it is possible to provide a three-dimensional structure manufacturing apparatus capable of manufacturing a three-dimensional structure having excellent mechanical strength with high productivity.

According to still another aspect of the invention, there is provided a three-dimensional structure that is manufactured using the method of the aspect of the invention.

Accordingly, it is possible to provide a three-dimensional structure having excellent mechanical strength.

According to still another aspect of the invention, there is provided a three-dimensional structure that is manufactured using the apparatus according to the aspect of the invention.

Accordingly, it is possible to provide a three-dimensional structure having excellent mechanical strength.

### BRIEF DESCRIPTION OF DRAWINGS

FIG. 1A is a cross-sectional view schematically illustrating each step of a method of manufacturing a three-dimensional structure according to a first embodiment of the invention.

FIG. 1B is a cross-sectional view schematically illustrating each step of the method of manufacturing a three-dimensional structure according to the first embodiment of the invention.

FIG. 1C is a cross-sectional view schematically illustrating each step of the method of manufacturing a three-dimensional structure according to the first embodiment of the invention.

FIG. 1D is a cross-sectional view schematically illustrating each step of the method of manufacturing a three-dimensional structure according to the first embodiment of the invention.

FIG. 2A is a cross-sectional view schematically illustrating each step of the method of manufacturing a three-dimensional structure according to the first embodiment of the invention.

FIG. 2B is a cross-sectional view schematically illustrating each step of the method of manufacturing a three-dimensional structure according to the first embodiment of the invention.

FIG. 2C is a cross-sectional view schematically illustrating each step of the method of manufacturing a three-dimensional structure according to the first embodiment of the invention.

FIG. 2D is a cross-sectional view schematically illustrating each step of the method of manufacturing a three-dimensional structure according to the first embodiment of the invention.

FIG. 3A is a cross-sectional view schematically illustrating each step of the method of manufacturing a three-dimensional structure according to the first embodiment of the invention.

FIG. 3B is a cross-sectional view schematically illustrating each step of the method of manufacturing a three-dimensional structure according to the first embodiment of the invention.

FIG. 3C is a cross-sectional view schematically illustrating each step of the method of manufacturing a three-dimensional structure according to the first embodiment of the invention.

FIG. 4A is a cross-sectional view schematically illustrating each step of a method of manufacturing a three-dimensional structure according to a second embodiment of the invention.

FIG. 4B is a cross-sectional view schematically illustrating each step of the method of manufacturing a three-dimensional structure according to the second embodiment of the invention.

FIG. 4C is a cross-sectional view schematically illustrating each step of the method of manufacturing a three-dimensional structure according to the second embodiment of the invention.

FIG. 4D is a cross-sectional view schematically illustrating each step of the method of manufacturing a three-dimensional structure according to the second embodiment of the invention.

FIG. 5A is a cross-sectional view schematically illustrating each step of the method of manufacturing a three-dimensional structure according to the second embodiment of the invention.

FIG. 5B is a cross-sectional view schematically illustrating each step of the method of manufacturing a three-dimensional structure according to the second embodiment of the invention.

FIG. 5C is a cross-sectional view schematically illustrating each step of the method of manufacturing a three-dimensional structure according to the second embodiment of the invention.

FIG. 5D is a cross-sectional view schematically illustrating each step of the method of manufacturing a three-dimensional structure according to the second embodiment of the invention.

FIG. 6A is a cross-sectional view schematically illustrating each step of the method of manufacturing a three-dimensional structure according to the second embodiment of the invention.

FIG. 6B is a cross-sectional view schematically illustrating each step of the method of manufacturing a three-dimensional structure according to the second embodiment of the invention.

FIG. 6C is a cross-sectional view schematically illustrating each step of the method of manufacturing a three-dimensional structure according to the second embodiment of the invention.

FIG. 7 is a cross-sectional view schematically illustrating a three-dimensional structure manufacturing apparatus according to a preferred embodiment of the invention.

FIG. 8 is a cross-sectional view schematically illustrating a state inside a layer (composition for three-dimensional forming) immediately before a binding liquid application step.

FIG. 9 is a cross-sectional view schematically illustrating a state in which particles are bound to each other by a hydrophobic binding agent.

### DESCRIPTION OF EMBODIMENTS

Hereinafter, preferred embodiments of the invention will be described in detail with reference to the accompanying drawings.

### [Method of Manufacturing Three-Dimensional Structure]

First, a method of manufacturing a three-dimensional structure according to an aspect of the invention will be described.

### First Embodiment

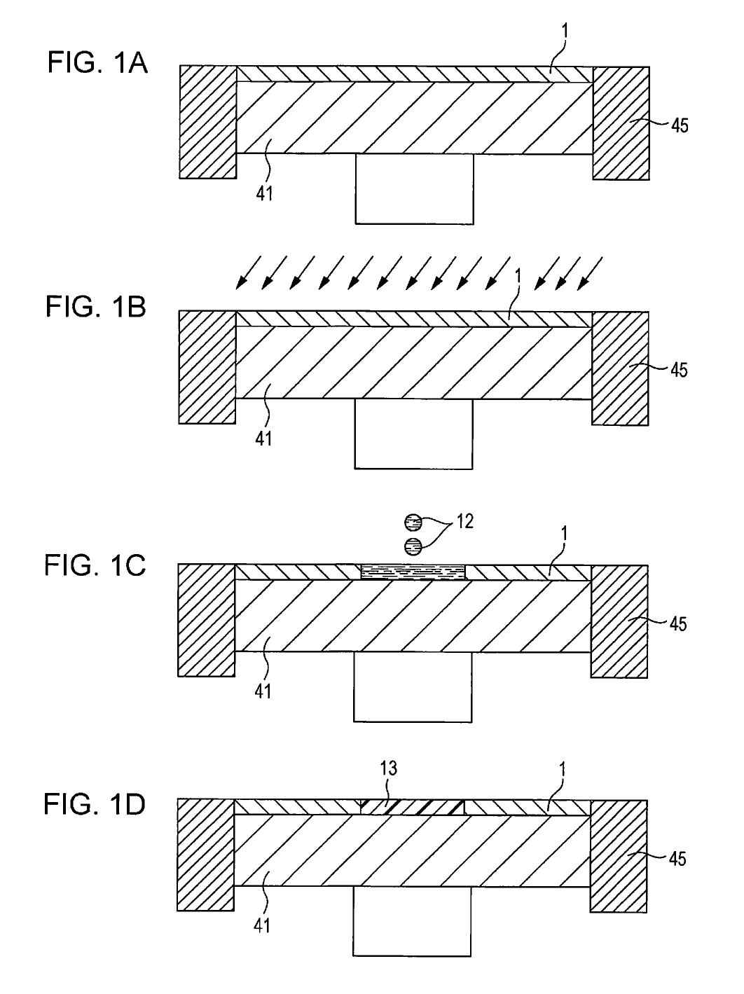

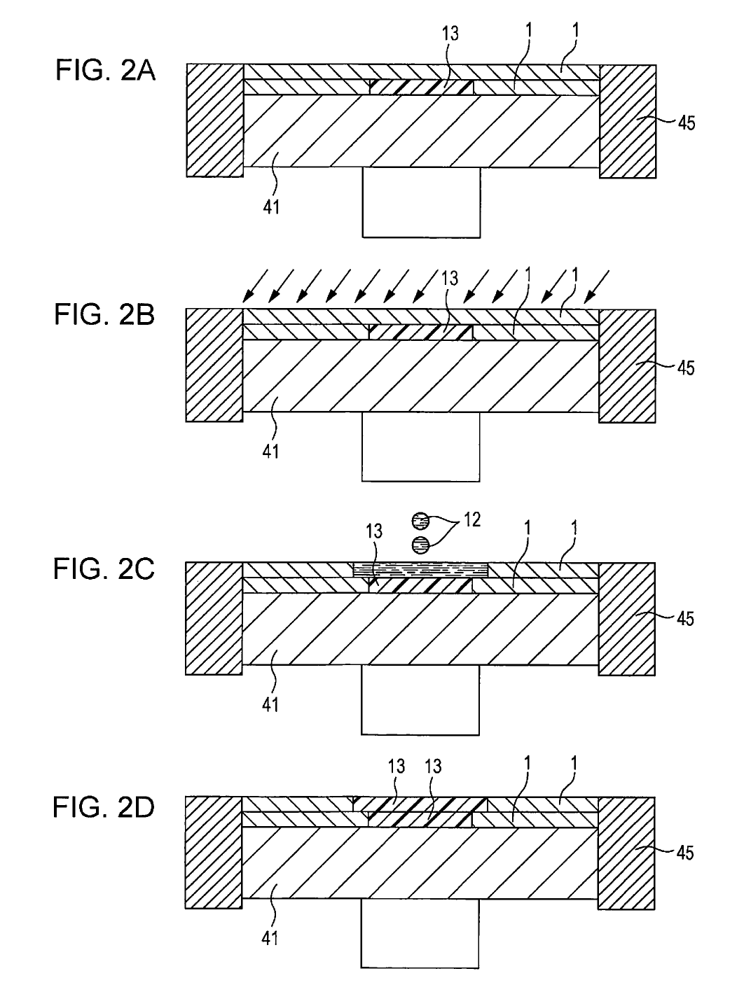

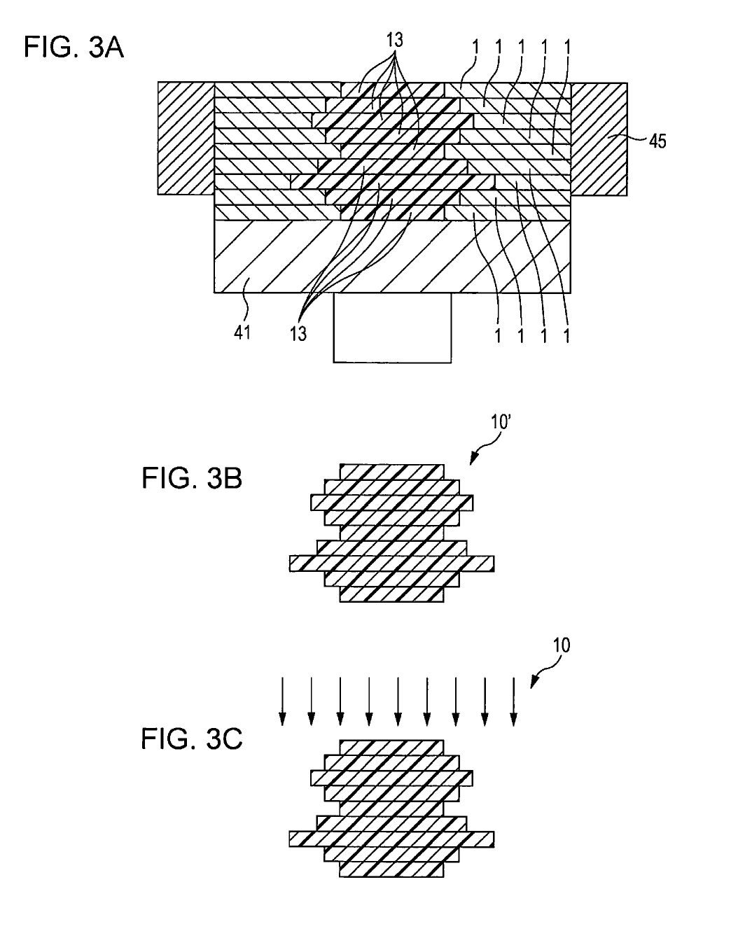

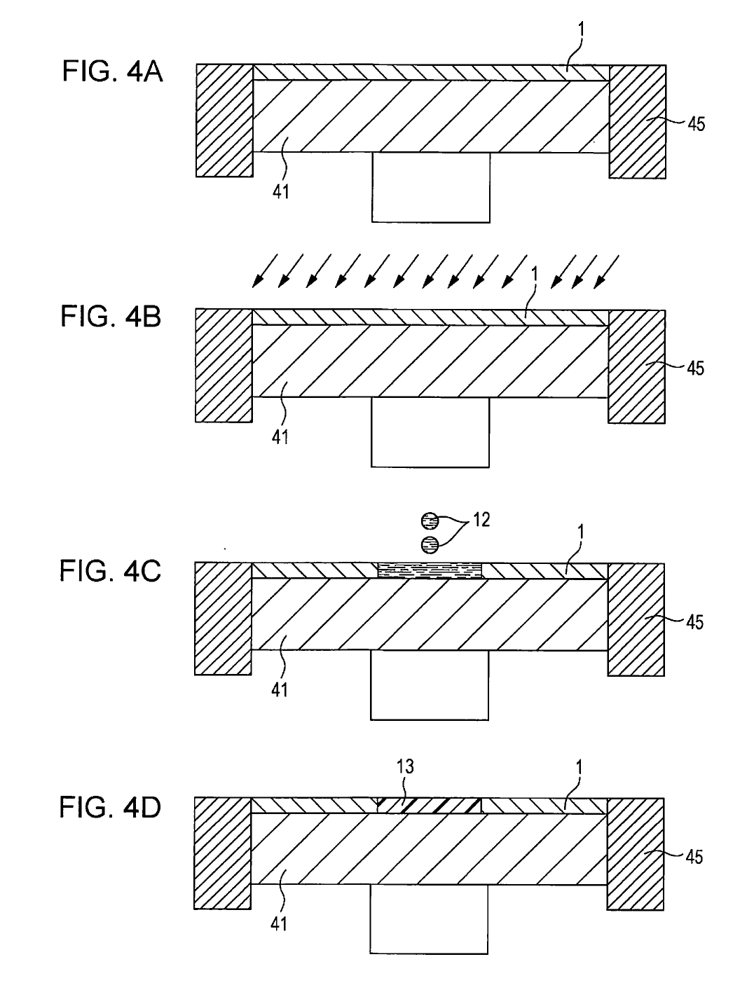

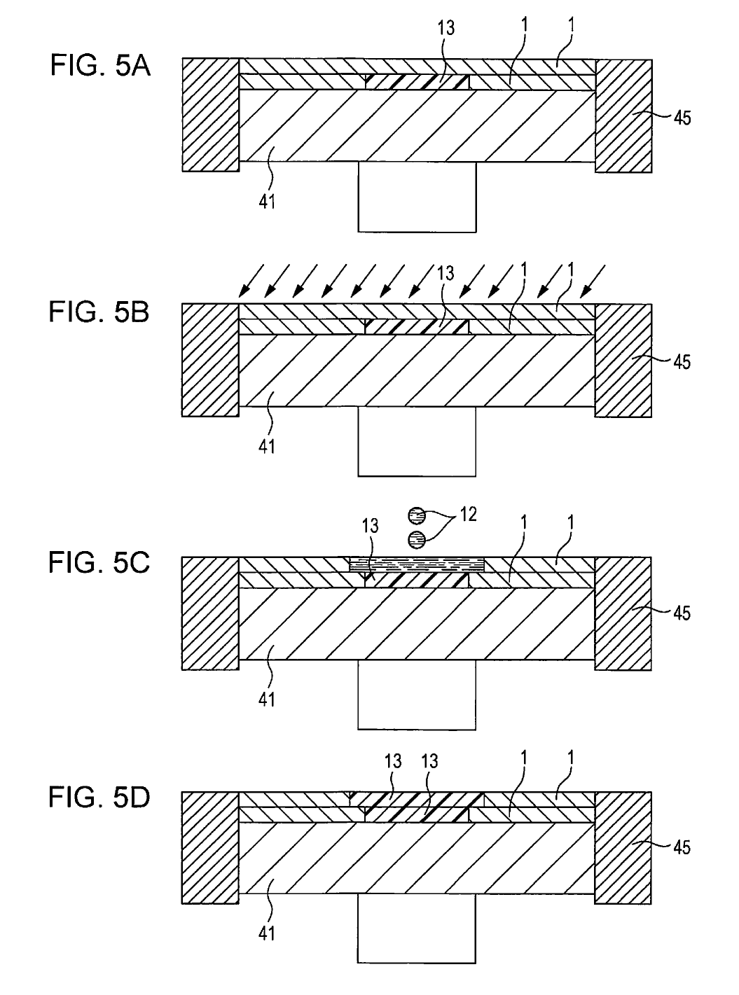

FIGS. 1A to 3C are cross-sectional views schematically illustrating each step of a method of manufacturing a three-dimensional structure according a first embodiment of the invention.

As shown in FIGS. 1A to 3C, the manufacturing method of the embodiment includes a layer forming step of forming a layer 1 having a predetermined thickness using a paste composition 11 including particles 111 and an aqueous solvent (1A and 2A), a layer heating step of heating the layer 1 (1B and 2B), a binding liquid application step of applying a binding liquid 12 to the layer 1 by an ink jet method (10 and 2C), and a curing step of curing a binding agent 121 included in the binding liquid 12 applied to the layer 1 and binding the particles 111 to form a cured portion (binding portion) 13 in the layer 1 (1D and 2D).

A temporary formed body 10′ is obtained by sequentially repeating these steps (3A) and the method further includes an unbound particle removing step (3B) of forming and then removing particles not bound by the binding agent 121 among the particles 111 constituting each layer 1 to extrude the temporary formed body 10′ and a temporary formed body heating step (3C) of heating the temporary formed body 10′.

Hereinafter, each step will be described.

### [Layer Forming Step]

In a layer forming step, a layer 1 having a predetermined thickness is formed using a paste composition (composition for three-dimensional forming) 11 including particles 111 and an aqueous solvent (1A and 2A).

By using a paste composition as the composition 11, the fluidity of the composition 11 is increased and thus the workability can be improved when the layer 1 is formed. Further, it is possible to prevent unintentional scattering of the powder (particles 111) when the layer 1 is formed or the like.

Particularly, since the composition 11 is formed into a paste, the composition includes an aqueous solvent.

Since the aqueous solvent generally has appropriate volatility, the solvent can be reliably prevented from unintentionally remaining in a finally obtained three-dimensional structure 10 while particularly improving the workability (ease of working, working efficiency) in the layer forming step.

The aqueous solvent has a strong binding force between molecules by hydrogen binding or the like and exhibits a strong effect of moving solvent molecules present in the inside surface (deep portion) of the layer 1 to the outer surface of the layer 1 along with removal of solvent molecules (aqueous solvent) from the layer 1 in a layer heating step, which will be described later, compared to a non-aqueous solvent. Accordingly, when the aqueous solvent is used, it is possible to prevent the solvent from unintentionally remaining in the layer 1 in an effective manner.

Further, the aqueous solvent is generally highly safe. Therefore, the safety of the operator when the three-dimensional structure 10 is manufactured is ensured and thus the aqueous solvent is preferable.

In the invention, the aqueous solvent refers to water or a liquid having high affinity with water, and specifically, a liquid whose solubility in 100 g of water at 25 degrees Celsius is 50 g or more.

Examples of the aqueous solvent include water; alcoholic solvents, such as methanol, ethanol, and isopropanol; ketone-based solvents such as methyl ethyl ketone and acetone; glycol ether-based solvents such as ethylene glycol monoethyl ether and ethylene glycol monobutyl ether; glycol ether acetate-based solvents such as propylene glycol 1-monomethyl ether 2-acetate and propylene glycol 1-monoethyl ether 2-acetate; polyethylene glycols; and polypropylene glycols. The solvents can be used singly or in combination of two or more.

Particularly, when the aqueous solvent includes water, effects of achieving a high degree of safety when the three-dimensional structure 10 is manufactured, a reduced load on the environment, a simple structure of a manufacturing apparatus due to recovery of the solvent being unnecessary, and being advantageous from the viewpoint of reducing the manufacturing cost of the three-dimensional structure 10 due to the low cost of the aqueous solvent among various solvents are obtained. In addition, since water has a more preferable volatility, it is possible to achieve particularly excellent workability in the layer forming step.

When the aqueous solvent includes water, the ratio of the water in the aqueous solvent is preferably 80% by mass or more, and more preferably 90% by mass or more.

Accordingly, the above-mentioned effects are more remarkably exhibited.

In addition, when the composition 11 includes the particles 111, the dimensional accuracy of the finally obtained three-dimensional structure 10 can be improved. Further, the heat resistance and mechanical strength of the three-dimensional structure 10 can be improved.

The composition 11 will be described later.

In the step, using flattening means, the surface of the layer 1 is formed to be flat.

In a first layer forming step, the layer 1 having a predetermined thickness is formed on the surface of a stage 41 (1A). At this time, the side surface of the stage 41 adheres to (is in contact with) a side surface support portion 45 and the composition 11 is prevented from falling between the stage 41 and the side surface support portion 45.

In a second and subsequent layer forming steps, a new layer 1 (second layer) is formed on the surface of the layer 1 (first layer) formed in the previous step (2A). At this time, the side surface of the layer 1 of the stage 41 (at least the uppermost layer 1 when plural layers 1 are formed on the stage 41) adheres to (is in contact with) the side surface support portion 45 and the composition 11 is prevented from falling between the stage 41 and the layer 1 on the stage 41.

The viscosity of the composition 11 in the step (a value measured using an E-type viscometer (VISCONIC ELD, manufactured by Tokyo Keiki Co., Ltd.)) is preferably 500 millipascal seconds or more and 60000 millipascal seconds or less, and more preferably 1000 millipascal seconds or more and 30000 millipascal seconds or less. Thus, it is possible to more effectively prevent unintentional unevenness in the thickness of the layer 1 to be formed from occurring.

The thickness of the layer 1 formed in the step is not particularly limited and for example, the thickness is preferably 5 micrometers or more and 500 micrometers or less and more preferably 10 micrometers or more and 100 micrometers or less.

Accordingly, unintentional unevenness in the manufactured three-dimensional structure 10 is more effectively prevented from occurring while the productivity of the three-dimensional structure 10 is sufficiently improved, and thus the dimensional accuracy of the three-dimensional structure 10 can be particularly increased. In addition, the aqueous solvent can be effectively removed in the layer heating step in a short period of time, and thus the mechanical strength of the finally obtained three-dimensional structure 10 can be particularly improved.

### [Layer Heating Step]

After the layer 1 is formed in the layer forming step, the layer 1 is subjected to a heating treatment (layer heating treatment) (1B and 2B).

Accordingly, the aqueous solvent included in the layer 1 evaporates, and thus the mechanical strength of the finally obtained three-dimensional structure 10 can be particularly improved.

In the step, it is preferable that a first heating treatment and a second heating treatment in which the layer is heated at a temperature higher in the first heating treatment are performed.

In this manner, by performing the first heating treatment and the subsequent second heating treatment in combination, the content of the aqueous solvent in the layer 1 can be effectively lowered. Thus, the content of the aqueous solvent in the three-dimensional structure 10 can be reliably reduced while the productivity of the three-dimensional structure 10 is improved. Accordingly, excellent strength in binding by a binding liquid 12 to be applied in the following step can be reliably achieved and thus the mechanical strength of the finally obtained three-dimensional structure 10 can be easily and reliably improved.

It is considered that such effects can be obtained by the following reasons.

That is, in the first heating treatment, while the speed of the aqueous solvent evaporating from the outer surface of the layer 1 and the speed of the aqueous solvent present in the inside (deep portion) of the layer 1 moving near the outer surface of the layer 1 are relatively increased, a good balance between the speeds can be achieved. As a result, the aqueous solvent is prevented from being trapped in the inside (deep portion) of the layer 1 and the content of the aqueous solvent present in the entire layer 1 can be effectively lowered. In addition, in the second heating treatment, since the heating temperature is high, the aqueous solvent remaining in the layer 1 is effectively removed and the content of the aqueous solvent present in the entire layer 1 can be sufficiently lowered. Accordingly, the binding between the particles with the binding liquid resulting can be effectively prevented from being inhibited by the aqueous solvent remaining in the layer 1. As a result, it is considered that the mechanical strength of the finally obtained three-dimensional structure 10 can be easily and reliably improved.

### [First Heating Treatment]

In the layer heating step, first, the first heating treatment is performed.

The first heating treatment is mainly performed for allowing the aqueous solvent present near the outer surface of the layer 1 formed in the layer forming step to evaporate at an appropriate speed and the aqueous solvent present in the inside (deep portion) of the layer 1 to move near the outer surface of the layer 1.

The heating temperature of the layer 1 in the first heating treatment is preferably lower than the temperature of the layer in the second heating treatment. The temperature is preferably 30 degrees Celsius or higher and 70 degrees Celsius or lower and more preferably 35 degrees Celsius or higher and 60 degrees Celsius or lower.

Accordingly, the mechanical strength of the three-dimensional structure 10 can be particularly improved while particularly improving the productivity of the three-dimensional structure 10.

The first heating treatment may be performed by any method. For example, a method of using a hot plate, a method of using an infrared heater, a method of using hot air, and the like can be used and a method of using hot air is preferable.

Accordingly, the aqueous solvent can evaporate from the outer surface of the layer 1 and the aqueous solvent can be moved to the outer surface from the inside (deep portion) of the layer 1 in a more effective manner and the productivity of the three-dimensional structure 10 can be particularly improved.

The wind speed of hot air in the first heating treatment is preferably 1.0 m/sec or more and 30 m/sec or less, and more preferably 2.0 m/sec or more and 20 m/sec or less.

Thus, the productivity of the three-dimensional structure 10 can be particularly improved while more reliably preventing unintentional deformation of the layer 1 or the like.

The treatment time for the first heating treatment (heating time) is preferably 0.1 second or more and 60 seconds or less and more preferably 0.1 second or more and 45 seconds or less.

Accordingly, the mechanical strength of the three-dimensional structure 10 can be particularly improved while particularly improving the productivity of the three-dimensional structure 10.

The first heating treatment may be collectively performed on the entire layer 1 or may be sequentially performed on each portion of the layer 1. When the first heating treatment is sequentially performed on each portion of the layer 1, it is preferable that the treatment time for each portion respectively satisfies the above-described condition.

When the first heating treatment is performed using hot air, the hot air is preferably blown from a direction inclined to the outer surface of the layer 1 (direction inclined to the layer 1 at a predetermined angle from a normal direction).

Accordingly, the aqueous solvent can evaporate from the outer surface of the layer 1 and the aqueous solvent can be moved to the outer surface from the inside (deep portion) of the layer 1 in a more effective manner and the productivity of the three-dimensional structure 10 can be further improved.

The angle theta between the normal line of the layer 1 and the direction from which the hot air is blown is preferably 10 degrees or more and 85 degrees or less and more preferably 30 degrees or more and 80 degrees or less.

Accordingly, the above-described effects are more remarkably exhibited.

In addition, the direction from which the hot air is blown may be constant or may be changed over time.

### [Second Heating Treatment]

The above-described first heating treatment is performed and then the second heating treatment is performed.

In the second heating treatment, the layer 1 is heated at a heating temperature that is higher than the heating temperature in the first heating treatment.

The second heating treatment is mainly performed for sufficiently lowering the content of the aqueous solvent in the entire layer 1 without deteriorating the productivity of the three-dimensional structure 10 by performing a heating treatment on the layer in which the content of the aqueous solvent is lowered by the above-described first heating treatment at a higher temperature.

The heating temperature of the layer 1 in the second heating temperature is preferably 40 degrees Celsius or higher and 120 degrees Celsius or lower and more preferably 45 degrees Celsius or higher and 90 degrees Celsius or lower.

Accordingly, the mechanical strength of the three-dimensional structure 10 can be particularly improved while particularly improving the productivity of the three-dimensional structure 10.

The second heating treatment may be performed by any method. For example, a method of using a hot plate, a method of using an infrared heater, a method of using hot air, and the like can be used and a method of using hot air is preferable.

Accordingly, the aqueous solvent can evaporate from the outer surface of the layer 1 and the aqueous solvent can be moved to the outer surface from the inside (deep portion) of the layer 1 in a more effective manner and the productivity of the three-dimensional structure 10 can be particularly improved.

The wind speed of the hot air in the second heating treatment is preferably 1.0 m/sec or more and 30 m/sec or less and more preferably 2.0 m/sec or more and 20 m/sec or less.

Accordingly, the productivity of the three-dimensional structure 10 can be particularly improved while more reliably preventing unintentional deformation of the layer 1 or the like.

The treatment time for the second heating treatment (heating time) is preferably 0.1 second or more and 60 seconds or less and more preferably 1 second or more and 45 seconds or less.

Accordingly, the mechanical strength of the three-dimensional structure 10 can be particularly improved while particularly improving the productivity of the three-dimensional structure 10.

The second heating treatment may be collectively performed on the entire layer 1 or may be sequentially performed on each portion of the layer 1. When the second heating treatment is performed on each portion of the layer 1, it is preferable that the treatment time for each portion respectively satisfies the above-described condition.

When the second heating treatment is performed using hot air, the hot air is preferably blown from a direction inclined to the outer surface of the layer 1 (direction inclined to the layer 1 at a predetermined angle from a normal direction).

Accordingly, the aqueous solvent can evaporate from the outer surface of the layer 1 and the aqueous solvent can be moved to the outer surface from the inside (deep portion) of the layer 1 in a more effective manner and the productivity of the three-dimensional structure 10 can be further improved.

The angle theta between the normal line of the layer 1 and the direction from which the hot air is blown is preferably 10 degrees or more and 85 degrees or less and more preferably 30 degrees or more and 80 degrees or less.

Accordingly, the above-described effects are more remarkably exhibited.

In addition, the direction from which the hot air is blown may be constant or may be changed over time.

### [Binding Liquid Application Step]

Next, the binding liquid 12 is applied to the layer 1 by an ink jet method to bind the particles 111 forming the layer 1 (1C and 2C).

In the step, the binding liquid 12 is applied only to a portion of the layer 1 which corresponds to the real portion (substantial portion) of the three-dimensional structure 10.

Accordingly, the particles 111 constituting the layer 1 are strongly bound to each other and thus a cured portion (binding portion) 13 having a finally desirable shape can be formed. In addition, the mechanical strength of the finally obtained three-dimensional structure 10 can be improved.

In the step, since the binding liquid 12 is applied by an ink jet method, the binding liquid 12 can be applied with good reproducibility even when the shape of the application pattern of the binding liquid 12 is fine. As a result, the dimensional accuracy of the finally obtained three-dimensional structure 10 can be particularly improved.

The binding liquid 12 will be described later.

### [Curing Step (Binding Step)]

After the binding liquid 12 is applied to the layer 1 in the binding liquid application step, a binding agent 121 included in the binding liquid 12 applied to the layer 1 is cured to form a cured portion (binding portion) 13 (1D and 2D).

Accordingly, particularly excellent binding strength between the binding agent 121 and the particle 111 can be obtained and as a result, the mechanical strength of the finally obtained three-dimensional structure 10 can be particularly improved.

In the step, a curing method differs depending on the type of the binding agent 121. For example, when the binding agent 121 is a thermosetting resin, the binding agent can be cured by heating and when the binding agent 121 is a photocurable resin, the binding agent can be cured by being irradiated with the corresponding light (for example, when the binding agent 121 is an ultraviolet curable resin, the binding agent can be cured by irradiation with ultraviolet rays).

The binding liquid application step and the curing step may be performed at the same time. That is, before the whole pattern of one entire layer 1 is formed, a curing reaction may be sequentially carried out from a portion to which the binding liquid 12 is applied.

In addition, for example, when the binding agent 121 is not a curable component, the step can be omitted. In this case, the above-described binding liquid application step serves as a binding step.

### [Unbound Particle Removing Step]

By repeating the series of the above-described steps, a temporary formed body 10′ is formed (3A). Then, an unbound particle removing step of removing particles which are not bound by the binding agent 121 (unbound particles) among the particles 111 constituting each layer 1 (3B) is performed. Accordingly, the temporary formed body 10′ is extruded.

Examples of the specific method of the step includes a method of sweeping unbound particles by a brush or the like, a method of removing unbound particles by suction, a method of blowing gas such as air, a method of applying a liquid such as water (for example, a method of immersing a laminated body obtained as described above in a liquid and a method of spraying a liquid), and a method of applying vibration such as ultrasonic vibration. In addition, the method can be used in combination of two or more selected from these methods. More specifically, a method of blowing a gas such as air and then immersing a laminated body in a liquid such as water, and a method of applying ultrasonic vibration in a state in which a laminated body is immersed in a liquid such as water can be used. Among these methods, a method of applying a liquid including water to a laminated body obtained as described above (particularly, a method of immersing a laminated layer in a liquid including water) is preferably used.

### [Temporary Formed Body Heating Step]

In the temporary formed body heating step, a heating treatment is performed on the temporary formed body 10′ (3C).

Accordingly, the internal stress is alleviated and a three-dimensional structure 10 having high resistance against impact or the like and excellent mechanical strength can be obtained. Further, since the internal stress of the thus-obtained three-dimensional structure 10 is alleviated, unintentional deformation is prevented and the shape can be stably maintained for a long period of time. Therefore, the three-dimensional structure 10 has excellent dimensional accuracy.

Particularly, in the embodiment, the temporary formed body heating step is performed after the unbound particle removing step (after particles 111 which are not bound by the binding liquid 12 are removed from the temporary formed body 10′).

Thus, thermal energy can be effectively applied to the temporary formed body 10′ and a treatment time in the step can be relatively shortened. As a result, the productivity of the three-dimensional structure 10 can be particularly improved. Further, even when the heating temperature in the step is relatively low, the inside (deep portion) of the temporary formed body 10′ can be sufficiently heated and thus unintentional deformation and deterioration in the constituent material of the three-dimensional structure 10 can be more effectively prevented and also the removing of the unbound particles is preferable from the viewpoint of energy saving.

The heat treatment (temporary formed body heating treatment) in the step may be performed by any method and examples thereof include a method of using a hot plate, a method of using an infrared heater, a method of using hot air, and the like can be used and a method of using an infrared heater is preferable.

Thus, the inside (deep portion) of the temporary formed body 10′ can be effectively heated. Accordingly, even when the size of the three-dimensional structure 10 to be manufactured is large, the method can suitably cope with the size.

In the step, in the case of using an infrared heater, the peak wavelength of the infrared rays emitted from the infrared heater is preferably 0.7 micrometers or more and 1000 micrometers or less and more preferably 15 micrometers or more and 100 micrometers or less.

Thus, the inside (deep portion) of the temporary formed body 10′ can be effectively heated. Accordingly, even when the size of the three-dimensional structure 10 to be manufactured is large, the method can suitably cope with the size.

The temporary formed body 10′ to be supplied in the temporary formed body heating step is formed by performing a heating treatment on the layer 1 to which the binding liquid 12 is applied before the step. More specifically, in the embodiment, the laminated body including the layer 1 to which the binding liquid 12 is applied is subjected to the above described layer heating treatment before the temporary formed body heating step.

In this case, the content of the aqueous solvent in the temporary formed body can be lowered and thus internal stress easily remains in the temporary formed body while the mechanical strength of the finally obtained three-dimensional structure can be improved. Therefore, unless a heating treatment is performed on the temporary formed body in such a case, the resistance against impact and the like is decreased and the mechanical strength of the three-dimensional structure cannot be increased. Further, the dimensional accuracy is also easily lowered.

Contrarily, in the invention, a heating treatment is performed on the temporary formed body and thus such problems can be reliability prevented from occurring. Thus, the mechanical strength, dimensional accuracy, and reliability of the three-dimensional structure can be improved. That is, when the layer to which the binding liquid is applied is subjected to a heating treatment before the temporary formed body heating step, the effects of the invention can be more remarkably exhibited.

The heating temperature in the step is preferably 50 degrees Celsius or higher and 180 degrees Celsius or lower and more preferably 55 degrees Celsius or higher and 120 degrees Celsius or lower.

Thus, the mechanical strength and dimensional accuracy of the three-dimensional structure 10 can be particularly improved while particularly improving the productivity of the three-dimensional structure 10. In addition, unintentional deformation and deterioration in the constituent material of the three-dimensional structure 10 can be more effectively prevented.

When the glass transition temperature of the binding agent 121 which binds the particles 111 in the temporary formed body 10′ is Tg [degrees Celsius], the heating temperature in the step is (Tg−20) degrees Celsius or higher and (Tg+20) degrees Celsius or lower and more preferably is (Tg−10) degrees Celsius or higher and (Tg+10) degrees Celsius or lower.

Thus, the mechanical strength and dimensional accuracy of the three-dimensional structure 10 can be particularly improved while particularly improving the productivity of the three-dimensional structure 10. In addition, unintentional deformation and deterioration in the constituent material of the three-dimensional structure 10 can be more effectively prevented.

The glass transition temperature is measured according to JIS K 7121.

Further, the heating temperature in the step is preferably higher than the heating temperature in the layer heating step.

Accordingly, the internal stress can be more effectively alleviated and thus the mechanical strength and dimensional accuracy of the three-dimensional structure 10 can be particularly improved.

In addition, the heating time in the step is preferably 1 minute or more and 180 minutes or less and more preferably 10 minutes or more and 120 minutes or less.

Accordingly, the mechanical strength and dimensional accuracy of the three-dimensional structure 10 can be particularly improved while particularly improving the productivity of the three-dimensional structure 10.

The temporary formed body heating treatment may be collectively performed on the entire temporary formed body 10′ or may be sequentially performed on each portion of the temporary formed body 10′. When the heating treatment is sequentially performed on each portion of the temporary formed body 10′, it is preferable that the treatment time for each portion respectively satisfies the above-described condition.

According to the above-described manufacturing method of the invention, it is possible to manufacture a three-dimensional structure having excellent mechanical strength with high productivity.

### Second Embodiment

Next, a second embodiment of the method of manufacturing a three-dimensional structure of the invention will be described.

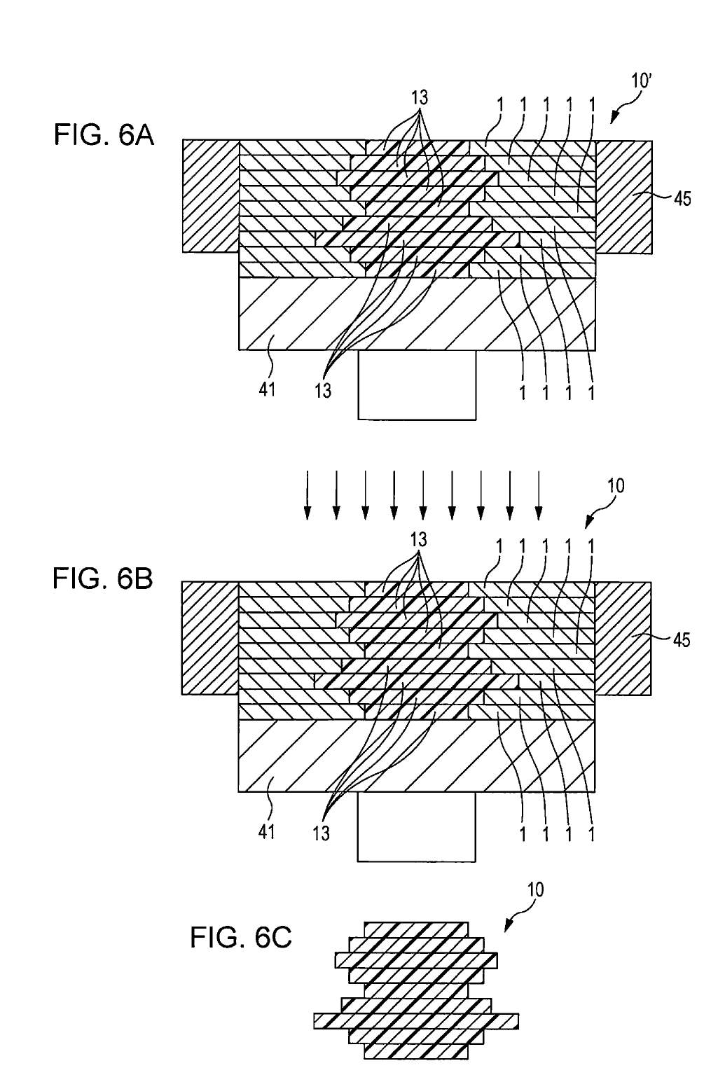

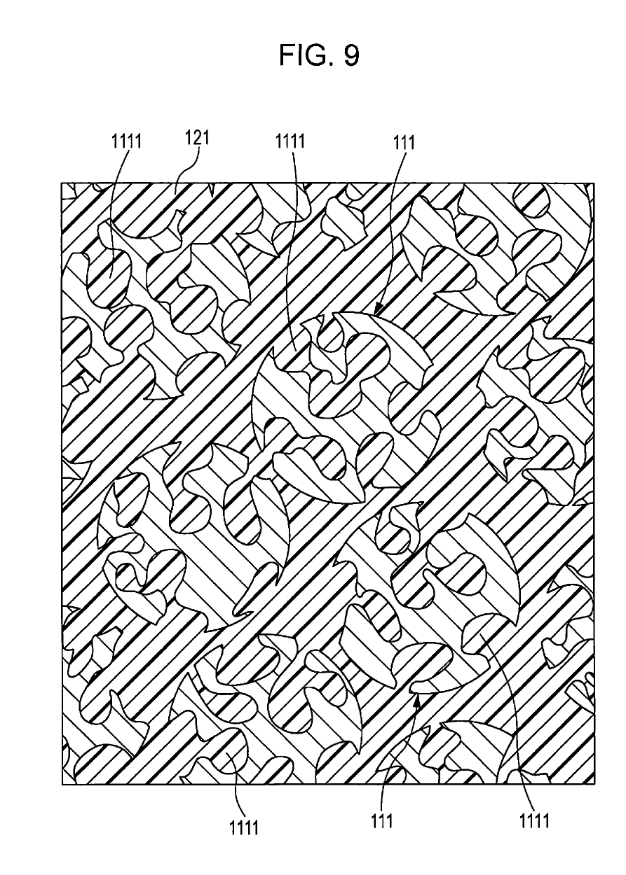

FIGS. 9A to 6C are cross-sectional views schematically illustrating each step of a method of manufacturing a three-dimensional structure according to a second embodiment of the invention. In the following description, the differences from the above-described embodiment will be mainly described and the same operations will be omitted.

As shown in FIGS. 9A to 6C, the manufacturing method of the embodiment includes a layer forming step of forming a layer 1 having a predetermined thickness using a paste composition 11 including particles 111 and an aqueous solvent (4A and 5A), a layer heating step of heating the layer 1 (4B and 5B), a binding liquid application step of applying a binding liquid 12 to the layer 1 by an ink jet method (4C and 5C), and a curing step of curing a binding agent 121 included in the binding liquid 12 applied to the layer 1 and binding the particles 111 to form a cured portion (binding portion) 13 in the layer 1 (4D and 5D). A temporary formed body 10′ is obtained by sequentially repeating these steps (6A) and the method further includes a temporary formed body heating step (6B) of heating the temporary formed body 10′ and an unbound particle removing step (6C) of removing particles not bound by the binding agent 121 among the particles 111 constituting each layer 1 to extrude a three-dimensional structure 10.

That is, in the above-described embodiment, after the temporary formed body 10′ is extruded (after the unbound particle removing step), the temporary formed body heating step is performed. However, in this embodiment, before the temporary formed body 10′ is extruded (in a state in which the temporary formed body is surrounded by particles not bound by the binding liquid), the temporary formed body heating step is performed and then a three-dimensional structure 10 obtained by the temporary formed body heating step is extruded.

With such a configuration, unintentional deformation of the structure or the like in the unbound particle removing step or after the unbound particle removing step can be reliably prevented. As a result, the dimensional accuracy of the three-dimensional structure 10 can be particularly improved.

### [Three-Dimensional Structure Manufacturing Apparatus]

Next, a three-dimensional structure manufacturing apparatus of the invention will be described.

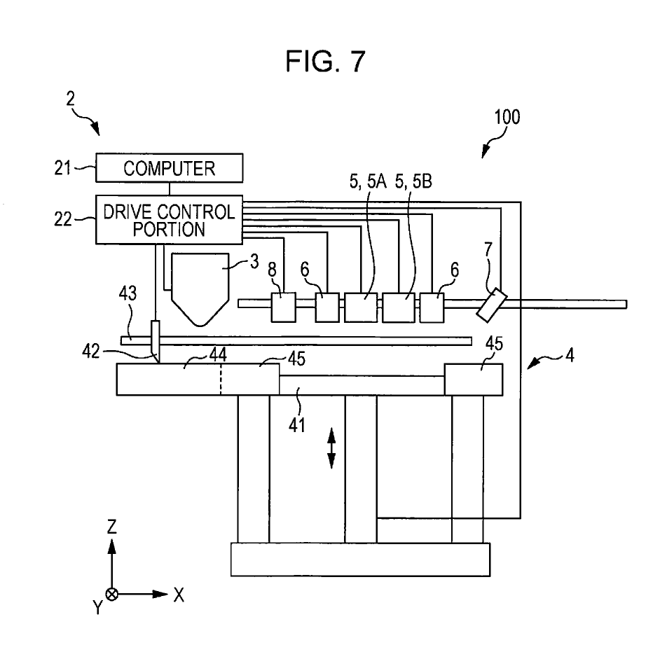

FIG. 7 is a cross-sectional view schematically illustrating a three-dimensional structure manufacturing apparatus according to a preferred embodiment of the invention.

A three-dimensional structure manufacturing apparatus 100 is an apparatus for manufacturing a three-dimensional structure 10 by repeatedly forming the layer 1 using the paste composition (composition for three-dimensional forming) 11 including the particles 111 and an aqueous solvent, and laminating the layer.

As shown in FIG. 7, the three-dimensional structure manufacturing apparatus 100 includes a control unit 2, a composition supply unit 3 that accommodates the paste composition 11 including the particles 111, a layer forming unit 4 that forms a layer 1 using the composition 11 supplied from the composition supply unit 3, heating means (layer heating means) 7 for heating the layer 1, a binding liquid discharge unit (binding liquid application means) 5 that discharges a binding liquid 12 to the layer 1, energy beam irradiation means (curing means) 6 for emits an energy beam to cure the binding liquid 12, and heating means (temporary formed body heating means) 8 for heating the temporary formed body 10′.

The control unit 2 has a computer 21 and a drive control portion 22.

The computer 21 is a general desktop computer provided with a CPU, a memory, and the like therein. The computer 21 converts the shape of the three-dimensional structure 10 into data as structure data and outputs cross-section data (slice data) obtained by slicing the three-dimensional structure into thin cross-sectional bodies of several parallel layers to the drive control portion 22.

The drive control portion 22 functions as control means for respectively driving the layer forming unit 4, the layer heating means 7, the binding liquid discharge unit 5, the energy beam irradiation means 6, and the like. Specifically, for example, the drive control portion controls the discharge pattern and the amount of the binding liquid 12 discharged from the binding liquid discharge unit 5, the amount of the composition 11 supplied from the composition supply unit 3, the amount of the stage 41 to be lowered, the heating conditions of the layer heating means 7 (heating temperature, wind speed of hot air, and the like), and the like.

The composition supply unit 3 is configured to move according to a command from the drive control portion 22 and to supply the composition 11 accommodated therein to a composition temporary placing portion 44.

The layer forming unit 4 has the composition temporary placing portion 44 that temporarily holds the composition 11 supplied from the composition supply unit 3, a squeegee (flattening means) 42 that forms the layer 1 while flattening the composition 11 held in the composition temporary placing portion 44, a guide rail 43 that regulates the operation of the squeegee 42, the stage 41 that supports the formed layer 1, and a side surface support portion (frame) 45 that surrounds the stage 41.

When a newly formed layer 1 is formed on the previously formed layer 1, the previously formed layer 1 is moved relatively downward to the side surface support portion 45. Thus, the thickness of the newly formed layer 1 is determined.

Particularly, in the embodiment, when the newly formed layer 1 is formed on the previously formed layer 1, the stage 41 is sequentially lowered by a predetermined amount according to the command from the drive control portion 22. In this manner, the stage 41 is configured to be movable in a Z-direction (vertical direction) and thus when the newly formed layer 1 is formed, the number of members to be moved to adjust the thickness of the layer 1 is reduced. Therefore, the configuration of the three-dimensional structure manufacturing apparatus 100 can be further simplified.

The surface of the stage 41 (portion to which the composition 11 is applied) is flat.

Accordingly, the layer 1 having high thickness uniformity can be easily and reliably formed. In addition, in the manufactured three-dimensional structure 10, unintentional deformation or the like can be effectively prevented from occurring.

The stage 41 is preferably formed of a material having high strength. Examples of the constituent material of the stage 41 include various metal materials including stainless steel.

In addition, the surface of the stage 41 (portion to which the composition 11 is applied) may not be subjected to a surface treatment. Accordingly, for example, the constituent material of the composition 11 and the constituent material of the binding liquid 12 are more effectively prevented from adhering to the stage 41 or the durability of the stage 41 is particularly improved and thus the three-dimensional structure 10 can be stably manufactured for a longer period of time. Examples of the material to be used for the surface treatment of the surface of the stage 41 include fluorine-based resins such as polytetrafluoroethylene.

The squeegee 42 has a longitudinal shape extending in a Y-direction and has a blade having an edge shape in which a lower tip end is projected.

The length of the blade in the Y-direction is equal to or more than the width of the stage 41 (forming region) (length in the Y-direction).

The three-dimensional structure manufacturing apparatus 100 may be provided with a vibration mechanism (not shown) that applies minute vibration to the blade so that the composition 11 is smoothly scattered by the squeegee 42.

The side surface support portion 45 has a function of supporting the side surface of the layer 1 formed on the stage 41. In addition, the side surface support portion also has a function of determining the area of the layer 1 when the layer 1 is formed.

Further, the surface of the side surface support portion 45 (portion in contact with the composition 11) may not be subjected to a surface treatment. Accordingly, for example, the constituent material of the composition 11 and the constituent material of the binding liquid 12 are more effectively prevented from adhering to the side surface support portion 45 or the durability of the side surface support portion 45 is particularly improved. Thus, the three-dimensional structure 10 can be stably manufactured fora longer period of time. Further, when the previously formed layer 1 is moved relatively downward to the side surface support portion 45, unintentional fluctuation in the layer 1 can be effectively prevented from occurring. As a result, the dimensional accuracy and reliability of the finally obtained three-dimensional structure 10 can be particularly improved. Examples of the material used for the surface treatment of the surface of the side surface support portion 45 include fluorine-based resins such as polytetrafluoroethylene.

The layer heating means 7 is means for performing a heating treatment (layer heating treatment) on the layer 1.

Particularly, in the embodiment, the layer heating means 7 performs the above-described first heating treatment and second heating treatment.

In this manner, single layer heating means 7 can perform the first heating treatment and the second heating treatment and thus, the configuration of the three-dimensional structure manufacturing apparatus 100 can be simplified.

For example, the conditions for the heating treatment may be controlled based on a detection result obtained by detecting the temperature of the layer 1 and the content of the aqueous solvent in the layer 1 by a sensor (not shown). Further, the heating conditions may be changed using a timer.

The binding liquid application means (binding liquid discharge unit) 5 is means for applying the binding liquid 12 to the layer 1.

Such binding liquid application means 5 is provided and thus the mechanical strength of the three-dimensional structure 10 can be easily and reliably improved.

Particularly, in the embodiment, the binding liquid application means 5 is a binding liquid discharge unit that discharges the binding liquid 12 by an ink jet method.

Accordingly, the binding liquid 12 can be applied with a fine pattern and even when the three-dimensional structure 10 has a fine configuration, the three-dimensional structure can be manufactured with particularly high productivity.

As a liquid droplet discharge method (ink jet method), a piezoelectric method, a method of discharging the binding liquid 12 by foam (bubbles) generated by heating the binding liquid 12, and the like can be used. However, from the viewpoint of the constituent component of the binding liquid 12 not being easily deteriorated, a piezoelectric method is preferable.

In the binding liquid discharge unit (binding liquid application means) 5, a pattern to be formed in each layer 1 and the amount of the binding liquid 12 to be applied to each portion of the layer 1 are controlled according to the command from the drive control portion 22. The discharge pattern and the amount of the binding liquid 12 discharged from the binding liquid discharge unit (binding liquid application means) 5 are determined based on the slice data.

The energy beam irradiation means (curing means) 6 is means for emitting an energy beam to cure the binding liquid 12 applied to the layer 1.

The type of the energy beam emitted from the energy beam irradiation means 6 differs depending on the constituent material of the binding liquid 12. However, examples thereof include ultraviolet rays, visible rays, infrared rays, X-rays, gamma-rays, electron beams, and ion beams. Among these, from the viewpoint of costs and the productivity of the three-dimensional structure, ultraviolet rays are preferably used.

The temporary formed body heating means 8 is means for performing a heating treatment (temporary formed body heating treatment) on the temporary formed body 10′.

For example, the conditions for heating treatment may be controlled based on a detection result obtained by detecting the temperature of the temporary formed body 10′ by a sensor (not shown). Further, the heating conditions may be changed using a timer.

According to the above-described three-dimensional structure manufacturing apparatus of the invention, a three-dimensional structure having excellent mechanical strength can be manufactured with high productivity.

### [Composition (Composition for Three-Dimensional Forming)]

Next, the composition (composition for three-dimensional forming) 11 used in manufacturing of the three-dimensional structure of the invention will be described in detail.

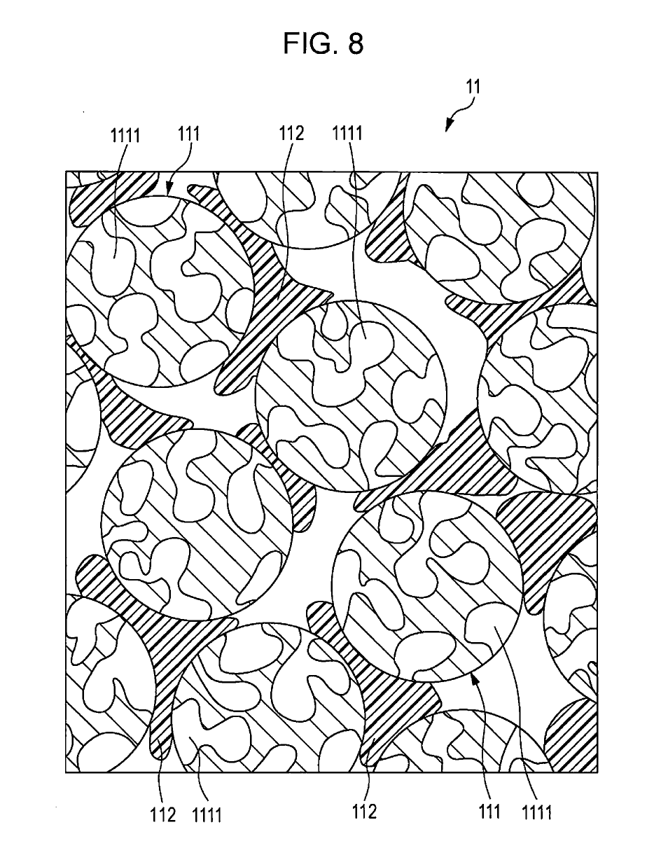

FIG. 8 is a cross-sectional view schematically illustrating a state inside the layer (composition for three-dimensional forming) immediately before the binding liquid application step, and FIG. 9 is a cross-sectional view schematically illustrating a state in which the particles are bound to each other by a hydrophobic binding agent.

The composition (composition for three-dimensional forming) 11 includes at least a powder for three-dimensional forming containing plural particles 111 and an aqueous solvent and is formed into a paste.

### [Powder for Three-Dimensional Forming (Particles 111)]

The particles 111 constituting the powder for three-dimensional forming are preferably porous and subjected to a hydrophobic treatment. Due to such a configuration, in the case in which the binding liquid 12 includes the hydrophobic binding agent 121, when the three-dimensional structure 10 is manufactured, the hydrophobic binding agent 121 can be preferably allowed to enter pores 1111 and an anchoring effect is exhibited. As a result, excellent binding force in binding between the particles 111 (binding force through the binding agent 121) can be obtained. Therefore, the three-dimensional structure 10 having excellent mechanical strength can be preferably manufactured (refer to FIG. 9). In addition, such a powder for three-dimensional forming can be preferably reused. More specifically, when the particles 111 constituting the powder for three-dimensional forming are subjected to a hydrophobic treatment, a water-soluble resin 112, which will be described later, is prevented from entering the pores 1111 and thus the particles 111 in a region to which the binding liquid 12 are not applied has a low content of impurities by being washed with water or the like in the manufacturing of the three-dimensional structure 10 and can be recovered with a high purity. Therefore, a composition for three-dimensional forming controlled to have a desired composition can be reliably obtained by re-mixing the recovered powder for three-dimensional forming with the water-soluble resin 112 and the like at a predetermined ratio. Further, since the binding agent 121 constituting the binding liquid, 12 enters the pores 1111 of the particles 111, unintentional wetting and spreading of the binding liquid 12 can be effectively prevented. As a result, the dimensional accuracy of the finally obtained three-dimensional structure 10 can be further increased.

Examples of the constituent material of the particle 111 (base particle which is subjected to a hydrophobic treatment) constituting the powder for three-dimensional forming includes inorganic materials, organic materials, and complexes thereof.

Examples of the inorganic materials constituting the particle 111 include various metals and metal compounds. Examples of the metal compounds include various metal oxides such as silica, alumina, titanium oxide, zinc oxide, zirconium oxide, tin oxide, magnesium oxide, and potassium titanate; various metal hydroxides such as magnesium hydroxide, aluminum hydroxide, and calcium hydroxide; various metal nitrides such as silicon nitride, titanium nitride, and aluminum nitride; various metal carbides such as silicon carbide, and titanium carbide; various metal sulfides such as zinc sulfide; various metal carbonates such as calcium carbonate, and magnesium carbonate; various metal sulfates such as calcium sulfate, and magnesium sulfate; various metal silicates such as calcium silicate, and magnesium silicate; various metal phosphates such as calcium phosphate; various metal borates such as aluminum borate, and magnesium borate; and composite compounds thereof.

Examples of the organic materials constituting the particle 111 include synthetic resins and natural polymers. Specific examples thereof include polyethylene resins; polypropylene; polyethylene oxides; polypropylene oxide, polyethyleneimine; polystyrene; polyurethane; polyurea; polyester; silicone resins; acrylic silicone resins; copolymers having (meth)acrylic ester such as polymethyl methacrylate as a constituent monomer; cross polymers having (meth)acrylic ester such as a methyl methacrylate cross polymer as a constituent monomer (ethylene acrylic acid copolymer resins and the like); polyamide resins such as nylon 12, nylon 6, and copolymer nylon; polyimide; carboxymethyl cellulose; gelatin; starch; chitin; and chitosan.

Among these, the particle 111 is preferably composed of an inorganic material, more preferably metal oxides, and still more preferably silica. Accordingly, the properties of the three-dimensional structure 10 such as mechanical strength and light resistance can be particularly improved. Further, particularly, when the particle 111 is composed of silica, the above-described effects are more effectively exhibited. In addition, since silica has excellent fluidity, silica is advantageous in forming the layer 1 having higher thickness uniformity and also advantageous in improving the productivity and dimensional accuracy of the three-dimensional structure 10.

As the hydrophobic treatment that has been performed on the particle 111 constituting the powder for three-dimensional forming, any treatment may be performed as long as the hydrophobicity of the particle 111 (base particle) is increased. However, a treatment in which a hydrocarbon group is introduced is preferable. Accordingly, the hydrophobicity of the particle 111 can be further increased. In addition, uniformity of the degree of hydrophobic treatment can be easily and reliably increased in each particle 111 and each portion of the surface of the particles 111 (including the surfaces inside the pores 1111).

As a compound used in the hydrophobic treatment, silane compounds including a silyl group are preferable. Specific examples of the compound that can be used in the hydrophobic treatment include hexamethyldisilazane, dimethyldimethoxysilane, diethyldiethoxysilane, 1-propenylmethyldichlorosilane, propyldimethylchlorosilane, propylmethyldichlorosilane, propyltrichlorosilane, propyltriethoxysilane, propyltrimethoxysilane, styrylethyltrimethoxysilane, tetradecyltrichlorosilane, 3-thiocyanatepropyltriethoxysilane, p-tolyldimethylchlorosilane, p-tolylmethyldichlorosilane, p-tolyltrichlorosilane, p-tolyltrimethoxysilane, p-tolyltriethoxysilane, di-n-propyldi-n-propoxysilane, diisopropyldiisopropoxysilane, di-n-butyldi-n-butyloxysilane, di-sec-butyldi-sec-butyloxysilane, di-t-butyldi-t-butyloxysilane, octadecyltrichlorosilane, octadecylmethyldiethoxysilane, octadecyltriethoxysilane, octadecyltrimethoxysilane, octadecyldimethylchlorosilane, octadecylmethyldichlorosilane, octadecylmethoxydichlorosilane, 7-octenyldimethylchlorosilane, 7-octenyltrichlorosilane, 7-octenyltrimethoxysilane, octylmethyldichlorosilane, octyldimethylchlorosilane, octyltrichlorosilane, 10-undecenyldimethylchlorosilane, undecyltrichlorosilane, vinyldimethylchlorosilane, methyloctadecyldimethoxysilane, methyldodecyldiethoxysilane, methyloctadecyldimethoxysilane, methyloctadecyldiethoxysilane, n-octylmethyldimethoxysilane, n-octylmethyldiethoxysilane, triacontyldimethylchlorosilane, triacontyltrichlorosilane, methyltrimethoxysilane, methyltriethoxysilane, methyltri-n-propoxysilane, methylisopropoxysilane, methyl-n-butyloxysilane, methyltri-sec-butyloxysilane, methyltri-t-butyloxysilane, ethyltrimethoxysilane, ethyltriethoxysilane, ethyltri-n-propoxysilane, ethylisopropoxysilane, ethyl-n-butyloxysilane, ethyltri-sec-butyloxysilane, ethyltri-t-butyloxysilane, n-propyltrimethoxysilane, isobutyltrimethoxysilane, n-hexyltrimethoxysilane, hexadecyltrimethoxysilane, n-octyltrimethoxysilane, n-dodecyltrimethoxysilane, n-octadecyltrimethoxysilane, n-propyltriethoxysilane, isobutyltriethoxysilane, n-hexyltriethoxysilane, hexadecyltriethoxysilane, n-octyltriethoxysilane, n-dodecyltrimethoxysilane, n-octadecyltriethoxysilane, 2-[2-(trichlorosilyflethyl]pyridine, 4-[2-(trichlorosilyl)ethyl]pyridine, diphenyldimethoxysilane, diphenyldiethoxysilane, 1,3-(trichlorosilylmethyl)heptacosane, dibenzyldimethoxysilane, dibenzyldiethoxysilane, phenyltrimethoxysilane, phenylmethyldimethoxysilane, phenyldimethylmethoxysilane, phenyldimethoxysilane, phenyldiethoxysilane, phenylmethyldiethoxysilane, phenyldimethylethoxysilane, benzyltriethoxysilane, benzyltrimethoxysilane, benzylmethyldimethoxysilane, benzyldimethylmethoxysilane, benzyldimethoxysilane, benzyldiethoxysilane, benzylmethyldiethoxysilane, benzyldimethylethoxysilane, benzyltriethoxysilane, dibenzyldimethoxysilane, dibenzyldiethoxysilane, 3-acetoxypropyltrimethoxysilane, 3-acryloxypropyltrimethoxysilane, allyltrimethoxysilane, allyltriethoxysilane, 4-aminobutyltriethoxysilane, (aminoethylaminomethyl)phenethyltrimethoxysilane, N-(2-aminoethyl)-3-aminopropylmethyldimethoxysilane, N-(2-aminoethyl)-3-aminopropyltrimethoxysilane, 6-(aminohexylaminopropyl)trimethoxysilane, p-aminophenyltrimethoxysilane, p-aminophenylethoxysilane, m-aminophenyltrimethoxysilane, m-aminophenylethoxysilane, 3-aminopropyltrimethoxysilane, 3-aminopropyltriethoxysilane, omega-aminoundecyltrimethoxysilane, amyltriethoxysilane, benzooxasilepin dimethyl ester, 5-(bicycloheptenyl)triethoxysilane, bis(2-hydroxyethyl)-3-aminopropyltriethoxysilane, 8-bromooctyltrimethoxysilane, bromophenyltrimethoxysilane, 3-bromopropyltrimethoxysilane, n-butyltrimethoxysilane, 2-chloromethyltriethoxysilane, chloromethylmethyldiethoxysilane, chloromethylmethyldiisopropoxysilane, p-(chloromethyl)phenyltrimethoxysilane, chloromethyltriethoxysilane, chlorophenyltriethoxysilane, 3-chloropropylmethyldimethoxysilane, 3-chloropropyltriethoxysilane, 3-chloropropyltrimethoxysilane, 2-(4-chlorosulfonylphenyl)ethyltrimethoxysilane, 2-cyanoethyltriethoxysilane, 2-cyanoethyltrimethoxysilane, cyanomethylphenethyltriethoxysilane, 3-cyanopropyltriethoxysilane, 2-(3-cyclohexenyl)ethyltrimethoxysilane, 2-(3-cyclohexenyl)ethyltriethoxysilane, 3-cyclohexenyl trichlorosilane, 2-(3-cyclohexenyl)ethyltrichlorosilane, 2-(3-cyclohexenyl)ethyldimethylchlorosilane, 2-(3-cyclohexenyl)ethylmethyldichlorosilane, cyclohexyldimethylchlorosilane, cyclohexylethyldimethoxysilane, cyclohexylmethyldichlorosilane, cyclohexylmethyldimethoxysilane, (cyclohexylmethyl)trichlorosilane, cyclohexyltrichlorosilane, cyclohexyltrimethoxysilane, cyclooctyltrichlorosilane, (4-cyclooctenyl)trichlorosilane, cyclopentyltrichlorosilane, cyclopentyltrimethoxysilane, 1,1-diethoxy-1-silacyclopenta-3-ene, 3-(2,4-dinitrophenylamino)propyltriethoxysilane, (dimethylchlorosilyl)methyl-7,7-dimethylnorpinane, (cyclohexylaminomethyl)methyldiethoxysilane, (3-cyclopentadienylpropyl)triethoxysilane, (N,N-diethyl-3-aminopropyl)trimethoxysilane, 2-(3,4-epoxycyclohexyl)ethyltrimethoxysilane, 2-(3,4-epoxycyclohexyl)ethyltriethoxysilane, (furfuryloxymethyl)triethoxysilane, 2-hydroxy-4-(3-triethoxypropoxy)diphenyl ketone, 3-(p-methoxyphenyl)propylmethyldichlorosilane, 3-(p-methoxyphenyl)propyltrichlorosilane, p-(methylphenethyl)methyldichlorosilane, p-(methylphenethyl)trichlorosilane, p-(methylphenethyl)dimethylchlorosilane, 3-morpholinopropyltrimethoxysilane, (3-glycidoxypropyl)methyldiethoxysilane, 3-glycidoxypropyltrimethoxysilane, 1,2,3,4,7,7-hexachloro-6-methyldiethoxysilyl-2-norbornene, 1,2,3,4,7,7-hexachloro-6-triethoxysilyl-2-norbornene, 3-iodopropyltrimethoxysilane, 3-isocyanatopropyltriethoxysilane, (mercaptomethyl)methyldiethoxysilane, 3-mercaptopropylmethyldimethoxysilane, 3-mercaptopropyldimethoxysilane, 3-mercaptopropyltriethoxysilane, 3-methacryloxypropylmethyldiethoxysilane, 3-methacryloxypropyltrimethoxysilane, methyl{2-(3-trimethoxysilylpropylamino)ethylamino}-3-propio nate, 7-octenyltrimethoxysilane, R—N-alpha-phenethyl-N′-triethoxysilylpropylurea, S—N-alpha-phenethyl-N′-triethoxysilylpropylurea, phenethyltrimethoxysilane, phenethylmethyldimethoxysilane, phenethyldimethylmethoxysilane, phenethyldimethoxysilane, phenethyldiethoxysilane, phenethylmethyldiethoxysilane, phenethyldimethylethoxysilane, phenethyltriethoxysilane, (3-phenylpropyl)dimethylchlorosilane, (3-phenylpropyl)methyldichlorosilane, N-phenylaminopropyltrimethoxysilane, N-(triethoxysilylpropyl)dansylamide, N-(3-triethoxysilylpropyl)-4,5-dihydroimidazole, 2-(triethoxysilylethyl)-5-(chloroacetoxy)bicycloheptane, (S)—N-triethoxysilylpropyl-o-menthocarbamate, 3-(triethoxysilylpropyl)-p-nitrobenzamide, 3-(triethoxysilyl)propyl succinic anhydride, N-[5-(trimethoxysilyl)-2-aza-1-oxo-pentyl]caprolactam, 2-(trimethoxysilylethyl)pyridine, N-(trimethoxysilylethyl)benzyl-N,N,N-trimethylammonium chloride, phenylvinyldiethoxysilane, 3-thiocyanatopropyltriethoxysilane, (tridecafluoro-1,1,2,2-tetrahydrooctyl)triethoxysilane, N—O-(triethoxysilyl)propyl}phthalamic acid, (3,3,3-trifluoropropyl)methyldimethoxysilane, (3,3,3-trifluoropropyl)trimethoxysilane, 1-trimethoxysilyl-2-(chloromethyl)phenylethane, 2-(trimethoxysilyl)ethylphenylsulfonyl azide, beta-trimethoxysilylethyl-2-pyridine, trimethoxysilylpropyldiethylenetriamine, N-(3-trimethoxysilylpropyl)pyrrole, N-trimethoxysilylpropyl-N,N,N-tributylammonium bromide, N-trimethoxysilylpropyl-N,N,N-tributylammonium chloride, N-trimethoxysilylpropyl-N,N,N-trimethylammonium chloride, vinylmethyldiethoxysilane, vinyltriethoxysilane, vinyltrimethoxysilane, vinylmethyldimethoxysilane, vinyldimethylmethoxysilane, vinyldimethylethoxysilane, vinylmethyldichlorosilane, vinylphenyldichlorosilane, vinylphenyldiethoxysilane, vinylphenyldimethylsilane, vinylphenylmethylchlorosilane, vinyltriphenoxysilane, vinyltris-t-butoxysilane, adamantylethyltrichlorosilane, allylphenyltrichlorosilane, (aminoethylaminomethyl)phenethyltrimethoxysilane, 3-aminophenoxydimethylvinylsilane, phenyltrichlorosilane, phenyldimethylchlorosilane, phenylmethyldichlorosilane, benzyltrichlorosilane, benzyldimethylchlorosilane, benzylmethyldichlorosilane, phenethyldiisopropylchlorosilane, phenethyltrichlorosilane, phenethyldimethylchlorosilane, phenethylmethyldichlorosilane, 5-(bicycloheptenyl)trichlorosilane, 5-(bicycloheptenyl)triethoxysilane, 2-(bicycloheptyl)dimethylchlorosilane, 2-(bicycloheptyl)trichlorosilane, 1,4-bis(trimethoxysilylethyl)benzene, bromophenyltrichlorosilane, 3-phenoxypropyldimethylchlorosilane, 3-phenoxypropyltrichlorosilane, t-butylphenylchlorosilane, t-butylphenylmethoxysilane, t-butylphenyldichlorosilane, p-(t-butyl)phenethyldimethylchlorosilane, p-(t-butyl)phenethyltrichlorosilane, 1,3-(chlorodimethylsilylmethyl)heptacosane, ((chloromethyl)phenylethyl)dimethylchlorosilane, ((chloromethyl)phenylethyl)methyldichlorosilane, ((chloromethyl)phenylethyl)trichlorosilane, ((chloromethyl)phenylethyl)trimethoxysilane, chlorophenyltrichlorosilane, 2-cyanoethyltrichlorosilane, 2-cyanoethylmethyldichlorosilane, 3-cyanopropylmethyldiethoxysilane, 3-cyanopropylmethyldichlorosilane, 3-cyanopropyldimethylchlorosilane, 3-cyanopropyldimethylethoxysilane, 3-cyanopropylmethyldichlorosilane, 3-cyanopropyltrichlorosilane, and alkylsilane fluoride. The compounds can be used singly or in combination of two or more.

Among these, hexamethyldisilazane is preferably used for hydrophobic treatment. Thus, the hydrophobicity of the particle 111 can be further increased. In addition, uniformity of the degree of hydrophobic treatment can be easily and reliably increased in each particle 111 and each portion of the surface of the particles 111 (including the surfaces inside the pores 1111).

When the hydrophobic treatment using a silane compound is performed in a liquid phase, the particles 111 (base particles) to be subjected to the hydrophobic treatment are immersed in the liquid including the silane compound, and then a desired reaction can be preferably carried out. Thus, it is possible to form a chemical adsorption film of the silane compound.

Further, when the hydrophobic treatment using a silane compound is performed in a gas phase, particles 111 (base particles) to be subjected to the hydrophobic treatment are exposed to the vapor of the silane compound and then a desired reaction can be preferably carried out. Thus, it is possible to form a chemical adsorption film of the silane compound.

The average particle size of the particles 111 constituting the powder for three-dimensional forming is not particularly limited and is preferably 1 micrometer or more and 25 micrometers or less, and more preferably 1 micrometer or more and 15 micrometers or less. Accordingly, the mechanical strength of the three-dimensional structure 10 can be particularly improved and unintentional evenness is effectively prevented from being occurring in the manufactured three-dimensional structure 10. Thus, the dimensional accuracy of the three-dimensional structure 10 can be particularly improved. In addition, the fluidity of the powder for three-dimensional forming and the fluidity of the paste composition (composition for three-dimensional forming) 11 including the powder for three-dimensional forming can be particularly improved and the productivity of the three-dimensional structure 10 can be particularly improved.

In the invention, the average particle size refers to a volume-based average particle size and for example, the average particle size can be obtained by measuring a dispersion obtained by adding methanol as a sample and dispersing particles for 3 minutes with an ultrasonic disperser using a 50 micrometers aperture of a coulter counter particle size distribution measurement device (TA-II type, manufactured by Coulter Electronics, Inc).

The Dmax of the particles 111 constituting the powder for three-dimensional forming is preferably 3 micrometers or more and 40 micrometers or less and more preferably 5 micrometers or more and 30 micrometers or less. Thus, the mechanical strength of the three-dimensional structure 10 can be particularly improved and unintentional unevenness is more effectively prevented from being occurring in the manufactured three-dimensional structure 10. Therefore, the dimensional accuracy of the three-dimensional structure 10 can be particularly improved. In addition, the fluidity of the powder for three-dimensional forming and the fluidity of the paste composition (composition for three-dimensional forming) 11 including the powder for three-dimensional forming can be particularly improved and the productivity of the three-dimensional structure 10 can be particularly improved.

The porosity of the particles 111 constituting the powder for three-dimensional forming is preferably 20% or more and more preferably 30% or more and 70% or less. Thus, a space (pore 1111) which the binding agent enters is sufficiently provided and the mechanical strength of the particle 111 itself can be improved and as a result, the mechanical strength of the three-dimensional structure 10 formed by the binding agent 121 entering the pore 1111 can be particularly improved. In the invention, the porosity of the particles refers to a ratio (volume ratio) of the pores present inside the particles to the appearance volume of the particles and when the density of the particles is rho [g/cm³] and the true density of the constituent material of the particles is rho₀ [g/cm³], the porosity is a value represented by {(rho₀−rho)/rho₀}×100.

The average pore size (diameter of micropores) of the particles 111 is preferably 10 nm or more and more preferably 50 nm or more and 300 nm or less. Accordingly, the mechanical strength of the finally obtained three-dimensional structure 10 can be particularly improved. Further, when the binding liquid 12 including a pigment (colored ink) is used in the manufacturing of the three-dimensional structure 10, the pigment can be preferably held in the pores 1111 of the particles 111. Therefore, the pigment can be prevented from being unintentionally scattered and thus an image having high accuracy can be more reliably formed.

The particles 111 constituting the powder for three-dimensional forming may have any shape and are preferably formed in a spherical shape. Accordingly, the fluidity of the powder for three-dimensional forming and the fluidity of the paste composition (composition for three-dimensional forming) 11 including the powder for three-dimensional forming can be particularly improved and the productivity of the three-dimensional structure 10 can be particularly improved. Unintentional unevenness is more effectively prevented from being occurring in the manufactured three-dimensional structure 10 and thus the dimensional accuracy of the three-dimensional structure 10 can be particularly improved.

The void ratio of the powder for three-dimensional forming is 20% or more and 90% or less and more preferably 30% or more and 70% or less. Thus, the mechanical strength of the three-dimensional structure 10 can be particularly improved. In addition, the fluidity of the powder for three-dimensional forming and the fluidity of the paste composition (composition for three-dimensional forming) 11 including the powder for three-dimensional forming can be particularly improved and the productivity of the three-dimensional structure 10 can be particularly improved. Unintentional unevenness is more effectively prevented from being occurring in the manufactured three-dimensional structure 10 and thus the dimensional accuracy of the three-dimensional structure 10 can be particularly improved. In the invention, the void ratio of the powder for three-dimensional forming is a ratio of the sum of the volume of pores of total particles constituting the powder for three-dimensional forming and the volume of voids present between the particles with respect to the volume of a container when the container having a predetermined volume (for example, 100 mL) is filled with the powder for three-dimensional forming, and the void ratio is a value represented by {(P₀−P)/P₀}×100 when the bulk density of the powder for three-dimensional forming is P [g/cm³], the true density of the constituent material of the powder for three-dimensional forming is P₀ [g/cm³].

The content of the powder for three-dimensional forming in the composition (composition for three-dimensional forming) 11 is preferably 5% by mass or more and 90% by mass or less and more preferably 10% by mass or more and 70% by mass or less. Accordingly, the fluidity of the composition (composition for three-dimensional forming) 11 can be sufficiently improved and the mechanical strength of the finally obtained three-dimensional structure 10 can be particularly improved.

### [Aqueous Solvent]

The composition 11 includes an aqueous solvent (not shown in FIG. 8) in addition to the particles 111.

Thus, the composition 11 can be preferably formed into a paste and the fluidity of the composition 11 can be stably improved and the productivity of the three-dimensional structure 10 can be particularly improved. This is because of the following reasons. That is, in the invention, when the binding portion is formed (binding liquid application step, curing step), from the viewpoint of achieving stability in the shape of the layer and preventing unintentional wetting and spreading of the binding liquid, it is preferable to lower the fluidity of the layer formed using the composition. However, when the composition includes a solvent, it is possible to lower the fluidity of the layer by removing (evaporating) the solvent. Contrarily, for example, during formation of the layer, when the components included in the composition are melted, it is necessary to decrease the temperature of the composition (layer) in order to lower the fluidity of the layer formed using the composition. Generally, the fluidity can be more easily and reliably adjusted in a case of removing a solvent compared to a case of such temperature adjustment. Further, in the fluidity adjustment by temperature adjustment, the fluidity of the layer is relatively significantly changed depending on temperature and thus it is not easy to stably control the fluidity of the layer. However, in the case of removing a solvent, it is possible to easily control the fluidity of the layer. In addition, when the components included in the composition are dissolved, it is necessary to repeat heating and cooling for the composition. While repeating of heating and cooling requires relatively large amount of energy, when a solvent is used, the amount of energy used can be suppressed. Accordingly, from the viewpoint of energy saving, the use of a solvent is preferable.

In addition, since the aqueous solvent has high affinity with water, the water-soluble resin 112, which will be described later, can be preferably dissolved. Thus, the fluidity of the composition 11 can be improved and unintentional unevenness in the thickness of the layer 1 formed using the composition 11 can be more effectively prevented. Further, when the layer 1 from which the aqueous solvent is removed is formed, the water-soluble resin 112 can be bound to the particles 111 over the entire layer 1 with high uniformity and thus unintentional composition unevenness can be more effectively prevented from occurring. Therefore, unintentional unevenness in mechanical strength at each portion of the finally obtained three-dimensional structure 10 can be more effectively prevented and the reliability of the three-dimensional structure 10 can be further increased. In the configuration shown in FIG. 8, the aqueous solvent is not shown and is present while being attached to a part of the outer surface of the particles 111 in a state in which the water-soluble resin 112 is precipitated. However, when the composition includes the aqueous solvent, for example, the water-soluble resin 112 is included in the composition 11 while being dissolved in the aqueous solvent and this solution may be present in a state in which the solution makes the surface of the particles 111 (for example, the surface of the particles 111 excluding the pores 1111) wet.

Examples of the aqueous solvent constituting the composition 11 include water; alcoholic solvents such as methanol, ethanol, and isopropanol; ketone-based solvents such as methyl ethyl ketone and acetone; glycol ether based solvents such as ethylene glycol monoethyl ether and ethylene glycol monobuthyl ether; glycol ether acetate-based solvents such as propylene glycol 1-monomethyl ether 2-acetate and propylene glycol 1-monomethyl ether 2-acetate; polyethylene glycol, and polypropylene glycol. The solvents can be used singly or in combination of two or more.

Among these, the composition 11 preferably includes water. Thus, the water-soluble resin 112 can be more reliably dissolved, and the fluidity of the composition 11 and uniformity in the composition of the layer 1 formed using the composition 11 can be particularly improved. In addition, water is easily removed in the layer heating step. Water is advantageous from the viewpoint of safety to a human body and environmental problems.

The content of the aqueous solvent in the composition 11 is preferably 5% by mass or more and 88% by mass or less and more preferably 10% by mass or more and 80% by mass or less. Thus, the above-described effects are more remarkably exhibited and the productivity of the three-dimensional structure 10 can be particularly improved.

### [Water-Soluble Resin]

The composition 11 may include plural particles 111 and the water-soluble resin 112.

When the composition includes the water-soluble resin 112, the particles 111 are bound (temporarily fixed) to each other in the portion of the layer 1 to which the binding liquid 12 is not applied (refer to FIG. 8) and unintentional scattering to the particles 111 can be more effectively prevented. Thus, the safety of a worker and the dimensional accuracy of the manufactured three-dimensional structure 10 can be further improved.

Even in the case in which the composition includes the water-soluble resin 112, when the particles 111 are not subjected to a hydrophobic treatment, the water-soluble resin 112 is effectively prevented from entering the pores 1111 of the particles 111. Therefore, the function of the water-soluble resin 112 of temporarily fixing the particles 111 is reliably exhibited and a problem that the water-soluble resin 112 enters the pores 1111 of the particles 111 in advance and a space which the binding agent 121 enters cannot be secured can be reliably prevented.

At least a part of the water-soluble resin 112 may be water-soluble. However, for example, the solubility in water at 25 degrees Celsius (mass soluble in 100 g of water) is preferably 5 [g/100 g water] or more and more preferably 10 [g/100 g water] or more.

Examples of the water-soluble resin 112 include synthetic polymers such as polyvinyl alcohol (PVA), polyvinyl pyrrolidone (PVP), polycaprolactone diol, sodium polyacrylate, ammonium polyacrylate, polyacrylamide, modified polyamide, polyethylene imine, polyethylene oxide, and a random copolymer of ethylene oxide and propylene oxide, natural polymers such as corn starch, mannan, pectin, agar, alginic acid, dextran, glue, and gelatin, and semisynthetic polymers such as carboxymethyl cellulose, hydroxyethyl cellulose, oxidized starch, and modified starch. The resins can be used singly or in combination of two or more.

Specific examples of water-soluble resin products include methyl cellulose (Metolose SM-15, manufactured by Shin-Etsu Chemical), hydroxyethyl cellulose (AL-15, manufactured by Fuji Chemical Industry Co., Ltd.), hydroxypropyl cellulose (HPC-M, manufactured by Nippon Soda Co., Ltd.), carboxymethyl cellulose (CMC-30, manufactured by Nichirin Chemical Industries, Ltd.), monosodium starch phosphate ester (Hostar-5100, manufactured by Matsutani Chemical Industry Co., Ltd.), polyvinylpyrrolidone (PVP K-90, manufactured by Tokyo Kagaku Kogyo K.K), a copolymer of methyl vinyl ether and maleic anhydride (AN-139, manufactured by GAF Chemicals Corporation), sodium polyacrylate (Aron T-50, Aron A-210, Aron AC-103, all manufactured by Toagosei Co., Ltd.), ammonium polyacrylate (Aron A-30SL, Aron AS-1100, Aron AS-1800, all manufactured by Toagosei Co., Ltd.), polyacrylamide (modified polyamide, manufactured by Wako Junyaku Inc.), modified polyamide (modified nylon) (AQ Nylon, manufactured by Toray Co., Ltd.), polyethylene oxide (PEO-1, manufactured by Seitetsu Kagaku Kogyo K.K, Alcox, manufactured by Meisei Chemical Works, Ltd.), a random copolymer of ethylene oxide and propylene oxide (Alcox EP, manufactured by Meisei Chemical Works, Ltd.), sodium polyacrylate (manufactured by Wako Junyaku Inc.), and carboxyvinyl polymer-crosslinking type acrylic-based water-soluble resin (Aqupec, manufactured by Sumitomo Seika Chemicals Co., Ltd).

Among these, when the water-soluble resin 112 is polyvinyl alcohol, the mechanical strength of the three-dimensional structure 10 can be particularly improved. In addition, by adjusting saponification or polymerization, the properties of the water-soluble resin 112 (for example, water solubility, water resistance, and the like) and the properties of the composition 11 (for example, viscosity, fixing force of particles 111, wettability and the like) can be more preferably controlled. Therefore, various three-dimensional structures 10 can be preferably manufactured. In addition, polyvinyl alcohol is cheap and stably supplied among various water-soluble resins. Therefore, it is possible to stably manufacture the three-dimensional structure 10 while suppressing the manufacturing cost.

When the water-soluble resin 112 includes polyvinyl alcohol, the saponification of the polyvinyl alcohol is preferably 75 or more and 98 or less. Accordingly, the solubility of the polyvinyl alcohol in water is prevented from being lowered. Therefore, when the composition 11 includes water, adhesion between the adjacent layers 1 can be more effectively prevented from being lowered.

When the water-soluble resin 112 includes polyvinyl alcohol, the polymerization of the polyvinyl alcohol is preferably 300 or more and 2500 or less. Accordingly, when the composition 11 includes water, the mechanical strength of each layer 1 and adhesion between the adjacent layers 1 can be particularly improved.

In addition, when the water-soluble resin 112 is polyvinyl pyrrolidone (PVP), the following effects can be obtained. That is, since polyvinyl pyrrolidone has excellent adhesion to various materials such as glass, metal, and plastic, stability in the strength and shape of the portion of the layer 1 to which the binding liquid 12 is not applied is particularly improved and the dimensional accuracy of the finally obtained three-dimensional structure 10 can be particularly improved. Further, since polyvinyl pyrrolidone has high solubility in various organic solvents, in the case in which the composition 11 includes an organic solvent, the fluidity of the composition 11 can be particularly improved and the layer 1 in which unintentional unevenness in thickness can be more effectively prevented can be more preferably formed. Thus, the dimensional accuracy of the finally obtained three-dimensional structure 10 can be particularly improved. In addition, since the polyvinyl pyrrolidone has high solubility in water, in the unbound particle removing step (after forming ends), particles which are not bound to each other by the binding agent 121 among the particles 111 constituting each layer 1 can be easily and reliably removed. Further, since polyvinyl pyrrolidone has appropriate affinity with the powder for three-dimensional forming, the wettability to the surface of the particles 111 is relatively high while the binding liquid does not sufficiently enter the above-described pores 1111. Therefore, the above-described function of temporarily fixing can be more effectively exhibited. Further, since polyvinyl pyrrolidone has excellent affinity with various colorants, in a case of using the binding liquid 12 including a colorant in the binding liquid application step, unintentional scattering of the colorant can be effectively prevented. In addition, when the paste composition 11 includes polyvinyl pyrrolidone, foam can be more effectively prevented from being entrained in the composition 11 and in the layer forming step, defects due to entrainment of foam can be more effectively prevented from occurring.

When the water-soluble resin 112 includes polyvinyl pyrrolidone, the weight average molecular weight of the polyvinyl pyrrolidone is preferably 10000 or more and 1700000 or less and more preferably 30000 or more and 1500000 or less. Accordingly, the above-described function can be more effectively exhibited.

The content of the water-soluble resin 112 in the composition 11 is preferably 0.1% by mass or more and 20% by mass or less and more preferably 0.2% by mass or more and 15% by mass or less. Accordingly, the above-described effects are more effectively exhibited and the productivity of the three-dimensional structure 10 can be particularly improved.

### [Other Components 1]

The composition 11 may include components other than above-described components. Examples of other components include a polymerization initiator; a polymerization accelerator; an infiltration accelerator; a wetting agent (moisturizing agent); a fixing agent; a fungicide; a preservative agent; an oxidation inhibitor; an ultraviolet absorbent; a chelate agent; a pH adjuster; and solvents other than the aqueous solvent.

### [Binding Liquid]

Next, a binding liquid used in the manufacturing of the three-dimensional structure of the invention will be described in detail.

The binding liquid 12 includes at least the binding agent 121.

### [Binding Agent]

The binding agent 121 may be any agent as long as the agent has a function of binding the particles 111. However, when the particles 111 having the pores 1111 which will be described later in detail and subjected to a hydrophobic treatment are used, a binding agent having hydrophobicity (lipophilicity) is preferable. Accordingly, the binding liquid 12 having high affinity with the particles 111 subjected to a hydrophobic treatment can be obtained, and thus the binding liquid 12 can preferably enter the pores 1111 of the particles 111 subjected to a hydrophobic treatment by applying the binding liquid 12 to the layer 1. As a result, an anchor effect is preferably exhibited by the binding agent 121 and thus the mechanical strength of the finally obtained three-dimensional structure 10 can be particularly improved. The hydrophobic binding agent is preferable as long as the affinity with water is sufficiently low. The solubility in water at 25 degrees Celsius is preferably 1 [g/100 g water] or less.

Examples of the binding agent 121 includes a thermoplastic resin; a thermosetting resin; various photocurable resins such as a visible ray curable resin curable by light in a visible region (photocurable resins in the narrow sense), an ultraviolet curable resin and an infrared curable resin; and an X-ray curable resin. The binding agents can be used singly or in combination of two or more. Among these, from the viewpoint of the mechanical strength of the obtained three-dimensional structure 10, the productivity of the three-dimensional structure 10, and the like, the binding agent 121 preferably include a curable resin. In addition, among various curable resins, from the viewpoint of the mechanical strength of the obtained three-dimensional structure 10, the productivity of the three-dimensional structure 10, the storage stability of the binding liquid 12, and the like, an ultraviolet curable resin (polymerizable compound) is particularly preferable.

As the ultraviolet curable resin (polymerizable compound), a resin in which when the resin is irradiated with ultraviolet rays, addition polymerization or ring opening polymerization is started by radicals or cations generated from a photopolymerization initiator to form a polymer is preferably used. Examples of the polymerization method of addition polymerization include radical, cationic, anionic, metathesis, and coordination polymerizations. In addition, examples of the polymerization method of ring open polymerization include cationic, anionic, radical, metathesis, and coordination polymerizations.

Examples of an addition polymerizable compound include a compound having at least one ethylenically unsaturated double bond. As the addition polymerizable compound, a compound having at least one terminal ethylenically unsaturated double bond and preferably having two or more terminal ethylenically unsaturated double bonds can be preferably used.

The ethylenically unsaturated polymerizable compound has chemical forms of a monofunctional polymerizable compound, a polyfunctional polymerizable compound, and a mixture thereof. Examples of the monofunctional polymerizable compound include unsaturated carboxylic acids (for example, acrylic acid, methacrylic acid, itaconic acid, crotonic acid, isocrotonic acid, maleic acid, and the like), esters thereof, and amides. Examples of the polyfunctional polymerizable compound include esters of unsaturated carboxylic acids and aliphatic polyvalent alcohol compounds and amides of unsaturated carboxylic acids and aliphatic polyvalent amine compounds.

Adducts of unsaturated carboxylic esters or amides having a nucleophilic substituent such as a hydroxyl group, an amino group, and a mercapto group with isocyanates and epoxies, dehydration condensates of these unsaturated carboxylic acid esters or amides with carboxylic acid, and the like can be used. In addition, the adducts of unsaturated carboxylic esters or amines having an electrophile substituent such as an isocyanate group and an epoxy group with alcohols, amines, and thiols, and substituted compounds of unsaturated carboxylic esters a releasable substituent such as a halogen group and a tosyloxy group or amines with alcohols, amines, or thiols can also used.

As a specific examples of a radical compound that is an ester of an unsaturated carboxylic acid and an aliphatic polyvalent alcohol compound, (meth)acrylate is representative and the compound may be monofunctional or polyfunctional.

Specific examples of monofunctional (meth)acrylate include tolyloxyethyl (meth)acrylate, phenyloxy (meth)acrylate, cyclohexyl (meth)acrylate, ethyl (meth)acrylate, methyl (meth)acrylate, isobornyl (meth)acrylate, and tetrahydrofurfuryl (meth)acrylate.

Specific examples of bifunctional (meth)acrylate include ethylene glycol di(meth)acrylate, triethylene glycol di(meth)acrylate, 1,3-butanediol di(meth)acrylate, tetramethylene glycol di(meth)acrylate, propylene glycol di(meth)acrylate, neopentyl glycol di(meth)acrylate, hexanediol di(meth)acrylate, 1,4-cyclohexanediol di(meth)acrylate, tetraethylene glycol di(meth)acrylate, pentaerythritol di(meth)acrylate, and dipentaerythritol di(meth)acrylate.

Specific examples of trifunctional (meth)acrylate include trimethylolpropane tri(meth)acrylate, trimethylolethane tri(meth)acrylate, alkylene oxide-modified trimethylolpropane tri(meth)acrylate, pentaerythritol tri(meth)acrylate, dipentaerythritol tri(meth)acrylate, trimethylolpropane tri((meth)acryloyloxypropyl)ether, isocyanuric acid alkylene oxide-modified tri(meth)acrylate, propionic acid dipentaerythritol tri(meth)acrylate, tri((meth)acryloyloxyethyl) isocyanurate, hydroxypivalic aldehyde-modified dimethylolpropane tri(meth)acrylate, and sorbitol tri(meth)acrylate.

Specific examples of tetrafunctional (meth)acrylate include pentaerythritol tetra(meth)acrylate, sorbitol tetra(meth)acrylate, ditrimethylolpropane tetra(meth)acrylate, propionic acid dipentaerythritol tetra(meth)acrylate, and ethoxylated pentaerythritol tetra(meth)acrylate.

Specific examples of pentafunctional (meth)acrylate include sorbitol penta(meth)acrylate and dipentaerythritol penta(meth)acrylate.

Specific examples of hexafunctional (meth)acrylate include dipentaerythritol hexa(meth)acrylate, sorbitol hexa(meth)acrylate, alkylene oxide-modified phosphazene hexa(meth)acrylate, and caprolactone-modified dipentaerythritol hexa(meth)acrylate.

Examples of polymerizable compounds other than (meth)acrylates include itaconate, crotonate, isocrotonate, and maleate.

Examples of itaconate include ethylene glycol diitaconate, propylene glycol diitaconate, 1,3-butanediol diitaconate, 1, 4-butanediol diitaconate, tetramethylene glycol diitaconate, pentaerythritol diitaconate, and sorbitol tetraitaconate.

Examples of crotonate include ethylene glycol dicrotonate, tetramethylene glycol dicrotonate, pentaerythritol dicrotonate, and sorbitol tetradicrotonate.

Examples of isocrotonate include ethylene glycol diisocrotonate, pentaerythritol diisocrotonate, and sorbitol tetraisocrotonate.

Examples of maleate include ethylene glycol dimaleate, triethylene glycol dimaleate, pentaerythritol dimaleate, and sorbitol tetramaleate.

Examples of other examples include the aliphatic alcohol esters described in JP-B-46-27926, JP-B-51-47334, and JP-A-57-196231, the esters having an aromatic skeleton described in JP-A-59-5240, JP-A-59-5241, and JP-A-2-226149, and the amino group-containing esters described in JP-A-1-165613.

Specific examples of monomers of amide of an aliphatic polyvalent amine compound and an unsaturated carboxylic acid include methylene bisacrylamide, methylene bismethacrylamide, 1,6-hexamethylene bisacrylamide, 1,6-hexamethylene bismethacrylamide, diethylenetriamine trisacrylamide, xylylene bisacrylamide, and xylylene bismethacrylamide.

Preferable examples of other amide monomers include amides having a cyclohexylene structure described in JP-B-54-21726.

Addition polymerizable urethane compounds formed by addition reaction of an isocyanate and a hydroxyl group are also preferable. Specific examples thereof include vinyl urethane compounds having two or more polymerizable vinyl groups in a molecule thereof, such as those described in JP-B-48-41708, which are prepared by adding a vinyl monomer having a hydroxyl group represented by the following Formula (1) to a polyisocyanate compound having two or more isocyanate group in a molecule.

CH₂═C(R¹)COOCH₂CH(R²)OH (1)

(In Formula (1), R¹ and R² each independently represent H or CH₃.)

In the invention, a cationic ring-opening polymerizable compound having one or more cyclic ether groups such as an epoxy group and an oxetane group in a molecule can be preferably used as an ultraviolet curable resin (polymerizable compound).

Examples of the cationic polymerizable compound include curable compounds having a ring-open polymerizable group. Among these, a heterocyclic group-containing curable compound is particularly preferable. Examples of the curable compound include cyclic iminoethers such as epoxy derivatives, oxetane derivatives, tetrahydrofuran derivatives, cyclic lactone derivatives, cyclic carbonate derivatives, and oxazoline derivatives, and vinyl ethers. Among these, epoxy derivatives, oxetane derivatives, and vinyl ethers are preferable.

Preferable examples of epoxy derivates include monofunctional glycidyl ethers, polyfunctional glycidyl ethers, monofunctional alicyclic epoxies, and polyfunctional alicyclic epoxies.

Specific examples of glycidyl ethers include diglycidyl ethers (for example, ethylene glycol diglycidyl ether and bisphenol A diglycidyl ether), tri- or higher functional glycidyl ethers (for example, trimethylolethane triglycidyl ether, trimethylolpropane triglycidyl ether, glycerol triglycidyl ether, and triglycidyl trishydroxyethyl isocyanurate), tetra- or higher functional glycidyl ethers (for example, sorbitol tetraglycidyl ether, pentaerythritol tetraglycidyl ether, a polyglycidyl ether of a cresol novolac resin, a polyglycidyl ether of a phenol novolac resin), alicyclic epoxies (for example, Celloxide 2021P, Celloxide 2081, Epolead GT-301, and Epolead GT-401 (all manufactured by Daicel Chemical Industries, Ltd.), EHPE (manufactured by Daicel Chemical Industries, Ltd.), and a polycyclohexyl epoxy methyl ether of a phenol novolac resin), and oxetanes (for example, OX-SQ, and PNOX-1009 (both manufactured by Toagosei Co., Ltd.)).

As the polymerizable compound, an alicyclic epoxy derivative can be preferably used. The “alicyclic epoxy group” referred herein means a partial structure that is formed by epoxidizing a double bond of a cycloalkene ring such as a cyclopentene group or a cyclohexene group using an appropriate oxidizing agent such as hydrogen peroxide or a peracid.

With regard to the alicyclic epoxy compound, polyfunctional alicyclic epoxies having at least two cyclohexene oxide groups or cyclopentene oxide groups in one molecule are preferable. Specific examples of alicyclic epoxy compounds include 4-vinylcyclohexene dioxide, (3,4-epoxycyclohexyl)methyl-3,4-epoxycyclohexyl carboxylate, di(3,4-epoxycyclohexyl) adipate, di(3,4-epoxycyclohexylmethyl) adipate, bis(2,3-epoxycyclopentyl) ether, di(2,3-epoxy-6-methylcyclohexylmethyl) adipate, and dicyclopentadiene dioxide.

A typical glycidyl compound having an epoxy group and having no alicyclic structure in the molecule can be used singly or in combination with the above alicyclic epoxy compounds.

Examples of such a typical glycidyl compound include a glycidyl ether compound and a glycidyl ester compound, and it is preferable to use a glycidyl ether compound in combination.

Specific examples of the glycidyl ether compound include aromatic glycidyl ether compounds such as 1,3-bis(2,3-epoxypropyloxy)benzene, a bisphenol A epoxy resin, a bisphenol F epoxy resin, a phenol novolac epoxy resin, a cresol novolac epoxy resin, and a trisphenolmethane epoxy resin, and aliphatic glycidyl ether compounds such as 1,4-butanediol glycidyl ether, glycerol triglycidyl ether, propylene glycol diglycidyl ether, and trimethylolpropane triglycidyl ether. Examples of the glycidyl ester include the glycidyl ester of linolenic acid dimer.

As the polymerizable compound, a compound having an oxetanyl group, which is a 4-membered cyclic ether (hereinafter, also referred to as simply an “oxetane compound”) can be used. The oxetanyl group-containing compound is a compound having one or more oxetanyl groups in one molecule.

The content of the binding agent in the binding liquid 12 is preferably 80% by mass or more and more preferably 85% by mass or more. Accordingly, the mechanical strength of the finally obtained three-dimensional structure 10 can be particularly improved.

### [Other Components 2]

The binding liquid 12 may include components other than the above-described components. Examples of such components include various colorants such as a pigment and a dye; a dispersant; a surfactant; a polymerization initiator; a polymerization accelerator; a solvent; an infiltration accelerator; a wetting agent (moisturizing agent); a fixing agent; a fungicide; a preservative agent; an oxidation inhibitor; an ultraviolet absorbent; a chelate agent; a pH adjuster; a thickening agent; a filler; an aggregation preventing agent; and an antifoaming agent.

Particularly, when the binding liquid 12 includes a colorant, the three-dimensional structure 10 colored in a color corresponding to the color of the colorant can be obtained.

Particularly, the light resistance of the binding liquid 12 and the three-dimensional structure 10 can be improved by including a pigment as the colorant. As the pigment, either of an inorganic pigment and an organic pigment can be used.

Examples of the inorganic pigment include carbon blacks (C.I. Pigment Black 7), such as furnace black, lamp black, acetylene black, and channel black, iron oxide, and titanium oxide. The pigments can be used singly or in combination of two or more.

Among these inorganic particles, titanium oxide is preferable to exhibit preferable white.

Examples of the organic pigment include azo pigments such as insoluble azo pigments, condensed azo pigments, azo lake, and chelate azo pigments; polycyclic pigments such as phthalocyanine pigments, perylene and perinone pigments, anthraquinone pigments, quinacridone pigments, dioxane pigments, thioindigo pigments, isoindolinone pigments, and quinophthalone pigments; dye chelates (such as basic dye chelates and acid dye chelates); dye lakes (such as basic dye lakes and acid dye lakes); and nitro pigments, nitroso pigments, aniline black, and daylight fluorescent pigments. The above pigments may be used singly or in combination of two or more.

More specifically, examples of carbon black used as a black color (black) pigment include No. 2300, No. 900, MCF88, No. 33, No. 40, No. 45, No. 52, MA7, MA8, MA100, and No. 2200B (all manufactured by Mitsubishi Chemical Corporation), Raven 5750, Raven 5250, Raven 5000, Raven 3500, Raven 1255, and Raven 700 (all manufactured by Carbon Columbia), Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all manufactured by Cabot Japan K.K), and Color Black FW1, Color Black FW2, Color Black FW2V, Color Black FW18, Color Black FW200, Color Black 5150, Color Black S160, Color Black S170, Printex 35, Printex U, Printex V, Printex 140U, Special Black 6, Special Black 5, Special Black 4A, and Special Black 4 (all manufactured by Degussa).

Examples of a white pigment include C.I. Pigment Whites 6, 18, and 21.

Examples of a yellow pigment include C.I. Pigment Yellows 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172 and 180.

Examples of a magenta pigment include C.I. Pigment Reds 1, 2, 3, 4, 5, 6, 7, 8, 9, 10, 11, 12, 14, 15, 16, 17, 18, 19, 21, 22, 23, 30, 31, 32, 37, 38, 40, 41, 42, 48(Ca), 48(Mn), 57(Ca), 57:1, 88, 112, 114, 122, 123, 144, 146, 149, 150, 166, 168, 170, 171, 175, 176, 177, 178, 179, 184, 185, 187, 202, 209, 219, 224 and 245, and C.I. Pigment Violets 19, 23, 32, 33, 36, 38, 43 and 50.

Examples of a cyan pigment include C.I. Pigment Blues 1, 2, 3, 15, 15:1, 15:2, 15:3, 15:34, 15:4, 16, 18, 22, 25, 60, 65 and 66, and C.I. Vat Blues 4 and 60.

Examples of pigments other than the above-described pigments include C.I. Pigment Greens 7 and 10, C.I. Pigment Browns 3, 5, 25, and 26, and C.I. Pigment Oranges 1, 2, 5, 7, 13, 14, 15, 16, 24, 34, 36, 38, 40, 43, and 63.

When the binding liquid 12 includes a pigment, the average particle size of the pigment is preferably 300 nm or less and more preferably 50 nm or more and 250 nm or less. Accordingly, the discharge stability of the binding liquid 12 and the dispersion stability of the pigment in the binding liquid 12 can be particularly improved and also an image having further excellent quality can be formed.

Examples of a dye include acid dyes, direct dyes, reactive dyes, and basic dyes. The dyes can be used singly or in combination of two or more.

Specific examples of the dye include C.I. Acid Yellows 17, 23, 42, 44, 79 and 142, C.I. Acid Reds 52, 80, 82, 249, 254 and 289, C.I. Acid Blues 9, 45 and 249, C.I. Acid Blacks 1, 2, 24 and 94, C.I. Food Blacks 1 and 2, C.I. Direct Yellows 1, 12, 24, 33, 50, 55, 58, 86, 132, 142, 144 and 173, C.I. Direct Reds 1, 4, 9, 80, 81, 225 and 227, C.I. Direct Blues 1, 2, 15, 71, 86, 87, 98, 165, 199 and 202, C.I. Direct Blacks 19, 38, 51, 71, 154, 168, 171 and 195, and C.I. Reactive Reds 14, 32, 55, 79 and 249, and C.I. Reactive Blacks 3, 4 and 35.

When the binding liquid 12 includes a colorant, the content of the colorant in the binding liquid 12 is preferably 1% by mass or more and 20% by mass or less. Thus, particularly excellent hiding performance and color reproducibility can be obtained.

Particularly, when the binding liquid 12 includes titanium oxide as the colorant in the binding liquid 12, the content of the titanium oxide in the binding liquid 12 is preferably 12% by mass or more and 30% by mass or less and more preferably 14% by mass or more and 25% by mass or less. Thus, particularly excellent hiding performance can be obtained.

When the binding liquid 12 includes a pigment and further includes a dispersant, the dispersibility of the pigment can be further improved. The dispersant is not particularly limited and examples thereof include dispersants typically used for preparing a pigment dispersant such as a polymer dispersant. Specific examples of the polymer dispersant include an agent containing at least one or more of polyoxyalkylene polyalkylene polyamines, vinyl polymers or copolymers, acrylic polymers or copolymers, polyesters, polyamides, polyimides, polyurethanes, amino polymers, silicon-containing polymers, sulfur-containing polymers, fluorine-containing polymers, and epoxy resins as a main component. Commercially available polymer dispersants include AJISPER series manufactured by Ajinomoto Fine-Techno, and SOLSPERSE series (Solsperse 36000 or the like) available from Noveon, Disperbyk series manufactured by BYK, and Disparlon series manufactured by Kusumoto Chemicals.

When the binding liquid 12 includes a surfactant, the abrasion resistance of the three-dimensional structure 10 can be further improved. The surfactant is not particularly limited and examples of a silicone surfactant include polyester-modified silicones and polyether-modified silicones. Among these, polyether-modified polydimethyl siloxane and polyester-modified polydimethyl siloxane are preferably used. Specific examples of the surfactant include BYK-347, BYK-348, and BYK-UV3500, 3510, 3530 and 3570 (all manufactured by BYK) may be used.

In addition, the binding liquid 12 may include a solvent. Accordingly, the viscosity of the binding liquid 12 can be preferably adjusted. Even when the binding liquid 12 includes a component having high viscosity, the discharge stability of the binding liquid 12 by an ink jet method can be particularly improved.

Examples of the solvent include (poly)alkylene glycol monoalkyl ethers such as ethylene glycol monomethyl ether, ethylene glycol monoethyl ether, propylene glycol monomethyl ether, and propylene glycol monoethyl ether; ester acetates such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl n-butyl ketone, diisopropyl ketone, and acetylacetone; and alcohols such as ethanol, propanol, and butanol. The solvents may be used singly or in combination of two or more.

The viscosity of the binding liquid 12 is preferably 1 millipascal second or more and 30 millipascal seconds or less and more preferably 3 millipascal seconds or more and 25 millipascal seconds or less. Thus, the discharge stability of the binding liquid 12 by an ink jet method can be particularly improved. In the specification, the viscosity is a value measured at 25 degrees Celsius using an E-type viscometer (VISCONIC ELD, manufactured by Tokyo Keiki Co., Ltd.) unless conditions are particularly designated.

Further, plural types of binding liquids 12 may be used in manufacturing of the three-dimensional structure 10.

For example, a binding liquid 12 including a colorant (color ink) and a binding liquid 12 not including a colorant (clear ink) may be used. Thus, for example, the binding liquid 12 including a colorant may be used as a binding liquid 12 to be applied to a region which affects a color tone in appearance of the three-dimensional structure 10, and the binding liquid 12 not including a colorant may be used as a binding liquid 12 to be applied to a region which does not affect a color tone in appearance of the three-dimensional structure 10. Further, in the finally obtained three-dimensional structure 10, plural types of binding liquids 12 may be used such that the region (coating layer) formed using the binding liquid 12 not including a colorant is provided on the outer surface of the region formed using the binding liquid 12 including a colorant.

In addition, for example, plural types of binding liquids 12 including colorants having different compositions may be used. Thus, a color remanufacturing region that can be expressed by combination of the plural types of binding liquids 12 can be widened.

When plural types of binding liquids 12 are used, at least, a cyan binding liquid 12, a magenta binding liquid 12 and a yellow binding liquid 12 are preferably used. Thus, a color remanufacturing region that can be expressed by combination of the plural types of binding liquids 12 can be widened.

In addition, when a white binding liquid 12 is used together with other color binding liquids 12, for example, the following effects can be obtained. That is, a first region to which the white binding liquid 12 is applied and a region (second region) which has color binding liquids 12 other than white color applied, is overlapped with the first region and is provided on the side closer to the outer surface than the first region can be provided in the finally obtained three-dimensional structure 10. Thus, the first region to which the white binding liquid 12 is applied exhibits hiding performance and the color saturation of the three-dimensional structure 10 can be further increased.

### [Three-Dimensional Structure]

The three-dimensional structure of the invention can be manufactured using the above-described manufacturing method and manufacturing apparatus.

Thus, it is possible to provide a three-dimensional structure having excellent mechanical strength.

The use of the three-dimensional structure of the invention is not particularly limited and for example, may be used for objects for appreciation and display such as dolls and figure dolls; and medical appliances such as implants.

In addition, the three-dimensional structure of the invention may be applied to any of prototypes, mass-manufactured goods, and order made goods.

The preferable embodiments of the invention have been described above. However, the invention is not limited thereto.

For example, in the above-described embodiment, the configuration in which the stage is lowered has been described as a representative example. However, in the manufacturing method of the invention, for example, the configuration in which the side surface support portion moves vertically may be used.

Further, as the flattening means, a roller may be used instead of the above described squeegee.

The three-dimensional structure manufacturing apparatus of the invention may include a recovery mechanism (not shown) that recovers some of the composition supplied from the composition supply unit, which are not used in layer formation. Thus, a sufficient amount of composition can be supplied while preventing an excessive composition in the layer formed portion from being accumulated. Therefore, defects can be more effectively prevented from occurring in the layer and the three-dimensional structure can be more stably manufactured. In addition, the recovered composition can be re-used in manufacturing of the three-dimensional structure, which contributes to reducing the manufacturing cost of the three-dimensional structure and is preferable from the viewpoint of saving resources.

The three-dimensional structure manufacturing apparatus of the invention may include a recovery mechanism that recovers the composition removed in the unbound particle removing step.

In addition, in the configuration shown in the drawing, the three-dimensional structure manufacturing apparatus is provided with the heating means for heating the layer and the heating means for heating the temporary formed body as a separate member. However, the layer and the temporary formed body may be heated using the same member (heating means).

In addition, in the configuration shown in the drawing, the three-dimensional structure manufacturing apparatus is provided with one heating means as the heating means for heating the layer (layer heating means). However, two or more heating means may be provided. Thus, for example, the conditions for the first heating treatment and the second heating treatment can be more preferably adjusted. Further, unintentional unevenness in the heating conditions in each portion of the layer can be more effectively suppressed.

In the above-described embodiment, the binding portion is formed in the whole layers. However, a layer in which the binding portion is not formed may be provided. For example, the binding portion may not be formed on the layer formed immediately on the stage and may function as a sacrificial layer.

In the above-described embodiment, the binding liquid application step is performed by an ink jet method. However, the binding liquid application step may be performed using other methods (for example, other printing methods).

In the above-described embodiment, in addition to the layer forming step and the binding liquid application step, the curing step is also repeated with layer forming step and the binding liquid application step. However, the curing step may not be repeated. For example, a laminated body having uncured plural layers may be formed and then the curing step may be collectively performed.

In the above-described embodiment, in a series of repeated steps, the binding liquid application step and the binding step are performed after the layer heating step is performed. However, the binding liquid application step and the binding step may be performed before the layer heating step.

In the manufacturing method of the invention, as necessary, a pre-treatment step, an intermediate treatment step, and a post-treatment step may be performed.

Examples of the pre-treatment step include a stage cleaning step.

Examples of the post-treatment step include a washing step, a shape adjusting step of performing deburring, a coloring step, a coating layer forming step, and a binding agent curing completion step of performing a light irradiation treatment to reliably cure an uncured binding agent.

In the above-described embodiment, the method having the binding liquid application step and the curing step (binding step) has been mainly described. However, for example, when a binding liquid including a thermoplastic resin as a binding agent is used, there is no need to provide a curing step (binding step) after the binding liquid application step (the binding liquid application step can function as the binding step). In this case, the three-dimensional structure manufacturing apparatus may not include an energy beam irradiation means (curing means).

In the above-described embodiment, the flattening means moves on the stage. However, the positional relationship between the stage and the squeegee is changed by moving the stage and the flattening may not be performed.

### REFERENCE SIGNS LIST

10 Three-dimensional structure
10′ Temporary formed body
1 Layer
11 Composition (composition for three-dimensional forming)
111 Particle
1111 Pore
112 Water-soluble resin
12 Binding liquid
121 Binding agent
13 Cured portion (binding portion)
100 Three-dimensional structure manufacturing apparatus
2 Control unit
21 Computer
22 Drive control portion
3 Composition supply unit
4 Layer forming unit
41 Stage
42 Squeegee (flattening means)
43 Guide rail
44 Composition placing portion
45 Side surface support portion (frame)
5 Binding liquid discharge unit (binding liquid application means)
6 Energy beam irradiation means (curing means)
7 Heating means (layer heating means)
8 Heating means (temporary formed body heating means)

1. A method of manufacturing a three-dimensional structure comprising:
a layer formation step of forming a layer using a composition including particles and an aqueous solvent; and
a binding liquid application step of applying a binding liquid to the layer to bind the particles,
wherein a temporary formed body obtained by repeating a series of steps including the layer formation step and the binding liquid application step, and
the method further comprises a temporary formed body heating step of performing a heating treatment on the temporary formed body.

2. The method of manufacturing a three-dimensional structure according to claim 1, wherein the temporary formed body heating step is performed after the particles which are not bound by the binding liquid are removed from the temporary formed body.

3. The method of manufacturing a three-dimensional structure according to claim 1, wherein the temporary formed body heating step is performed in a state in which the temporary formed body is surrounded by the particles which are not bound by the binding liquid and then the particles which are not bound by the binding liquid are removed.

4. The method of manufacturing a three-dimensional structure according to claim 1, wherein a heating temperature in the temporary formed body heating step is 50 degrees Celsius or higher and 180 degrees Celsius or lower.

5. The method of manufacturing a three-dimensional structure according to claim 1, wherein when a glass transition temperature of a binding agent which binds the particles in the temporary formed body is Tg (degrees Celsius), a heating temperature in the temporary formed body heating step is (Tg−20) degrees Celsius or higher and (Tg+20) degrees Celsius or lower.

6. The method of manufacturing a three-dimensional structure according to claim 1, wherein a heating time in the temporary formed body heating step is 1 minute or more and 180 minutes or less.

7. The method of manufacturing a three-dimensional structure according to claim 1, wherein an infrared heater is used in the temporary formed body heating step.

8. The method of manufacturing a three-dimensional structure according to claim 1, wherein the layer to which the binding liquid is applied is subjected to a heating treatment before the temporary formed body heating step.

9. The method of manufacturing a three-dimensional structure according to claim 1, wherein the series of steps further include a layer heating step of performing a heating treatment on the layer between the layer formation step and the binding liquid application step.

10. The method of manufacturing a three-dimensional structure according to claim 9, wherein a first heating treatment and a second heating treatment in which the layer is heated at a temperature higher than in the first heating treatment are performed in the layer heating step.

11. The method of manufacturing a three-dimensional structure according to claim 9, wherein hot air is used in the layer heating step.

12. The method of manufacturing a three-dimensional structure according to claim 9, wherein a heating temperature in the first heating treatment is 30 degrees Celsius or higher and 70 degrees Celsius or lower.

13. The method of manufacturing a three-dimensional structure according to claim 9, wherein a heating temperature in the second heating treatment is 40 degrees Celsius or higher and 120 degrees Celsius or lower.

14. The method of manufacturing a three-dimensional structure according to claim 9, wherein a treatment time for the first heating treatment is 0.1 second or more and 60 seconds or less.

15. The method of manufacturing a three-dimensional structure according to claim 9, wherein a treatment time for the second heating treatment is 0.1 second or more and 60 seconds or less.

16. The method of manufacturing a three-dimensional structure according to claim 9, wherein the heating temperature in the temporary formed body heating step is higher than the heating temperature in the layer heating step.

17. A three-dimensional structure manufacturing apparatus that manufactures a three-dimensional structure by laminating layers using a composition including particles, the apparatus comprising:
a stage on which the layer is formed by applying the composition;
binding liquid application means for applying a binding liquid to the layer to bind the particles; and
temporary formed body heating means for performing a heating treatment on a temporary formed body formed by laminating the layers to which the binding liquid is applied.

18. A three-dimensional structure that is manufactured using the method according to claim 1.

19. A three-dimensional structure that is manufactured using the apparatus according to claim 17.
